(19) United States
(12) Patent Application Publication
(10) Pub. No.: US 2020/0130510 A1
(43) Pub. Date: Apr. 30, 2020

(54) SYSTEM AND METHOD FOR AUTONOMOUS SHIPPING

(71) Applicants: Brandon ECK, Washington, DC (US); Brett WAGNER, Natick, MA (US); Shashank THAKKER, Avenel, NJ (US)

(72) Inventors: Brandon ECK, Washington, DC (US); Brett WAGNER, Natick, MA (US); Shashank THAKKER, Avenel, NJ (US)

(21) Appl. No.: 16/175,178

(22) Filed: Oct. 30, 2018

(51) Int. Cl. B60L 11/18; G06Q 10/08; G05D 1/00; G08G 5/00

(52) U.S. Cl. CPC B60L 11/1824; G06Q 10/0833; G06Q 10/0836; G05D 1/0088; B64C 39/024; B60L 11/1822; B60L 2200/36; B60L 2200/10; G08G 5/003

(57) ABSTRACT

An autonomous shipping system is inclusive of a delivery server that manages the several shipping assets for fulfilling shipping requests to transport packages between origin and destination locations through the coordinated interactions of distributed shipping assets that include service drones and service stations. Service drones are inclusive of delivery drones for holding and transporting packages and charge drones that carry additional power capacities and which are adapted to interact with delivery drones for executing power renewal routines for providing additional power to the power units of delivery drones. Service stations include docking stations that serve as shelters and recharging stations for one or more service drones, transfer stations for transferring packages between two delivery drones, and storage stations for temporarily storing packages during mid-shipment.

### CROSS-REFERENCE TO RELATED U.S. PATENTS AND PATENT APPLICATIONS

The present invention is inclusive of subject matter related to U.S. Pat. No. 9,975,651 (granted May 22, 2018), as well as co-pending U.S. patent application Ser. No. 15/821,266 (filed Nov. 22, 2017) and Ser. No. 15/949,791 (filed Apr. 10, 2018). The entire content and disclosure of each of the foregoing documents is hereby expressly incorporated by reference in this document.

### FIELD OF THE INVENTION

The present invention relates to an autonomous shipping system for transporting packages with a plurality of service drones and service stations, with transport of a single package being made possible through the cooperation of multiple different types of service drones and service stations, and with the continuous operation of individual delivery drones being made possible through the cooperation of charge drones.

### BACKGROUND OF THE INVENTION

Recent technological developments have allowed a number of industries to benefit from the low cost and efficient operations of unmanned drones, including unmanned ground vehicles (UGVs) and unmanned aerial vehicles (UAVs). For example, the agriculture industry uses UAVs to survey land and monitor irrigation systems; the filming industry uses UAVs to capture camera shots that are not possible using conventional filming methods; and the architecture industry uses UAVs to create 3D images of properties for rendering structural landscapes. Similarly, many companies in the delivery industry have begun to realize the potential benefits unmanned drones, including UAVs and UGVs, in for the performance of autonomous delivery methods.

A recent technological development in the delivery industry has included the development of a transfer station and system for transferring delivery containers between UAVs and UGVs, such as that disclosed in U.S. Pat. No. 9,975,651 and U.S. patent application Ser. No. 15/949,791, the entire content and disclosure both of which are hereby incorporated by reference. With such a transfer station and system, a UAV carrying an item for delivery may transfer the item to a UGV, and the UGV may then complete at least a portion of the delivery route along the ground, thereby avoiding concerns associated with a UAV flight path. The UGV may perform any of an initial portion, a final portion, or an intermediate portion of a delivery route, and may optionally perform only a limited ground transport after which the UGV may arrive at a second transfer station to transfer the item to a second UAV.

Another technological development relative in the delivery industry has included the development of a storage station that may for receiving and storing delivery containers during mid-shipment, such as that disclosed in U.S. patent application Ser. No. 15/821,266, the entire content and disclosure of which is hereby incorporated by reference. With such a storage station, a UAV or UGV carrying an item for delivery may transfer the item to the storage station for temporary storage, either for subsequent retrieval by an unmanned vehicle of a different type (e.g., UGV-UAV transfers, or vice versa) or simply for temporary storage to await delivery at a later scheduled time.

However, even with these recent developments, there remains certain inefficiencies in the execution of autonomous delivery by unmanned drones. One such inefficiency is encountered in the power capacity of the unmanned drones—specifically, the power units of these drones periodically require recharging which necessarily results in downtime during which the drones are not fulfilling outstanding shipping requests. The amount of downtime is further prolonged by requiring that the unmanned drones return to a charging station in place of continuing along a delivery route.

### SUMMARY OF THE INVENTION

The present invention seeks to address the downtime incurred by the power limitations of unmanned drones by providing an autonomous shipping system having power renewal means that are distributed throughout the shipping system.

An autonomous shipping system according to the present invention is adapted for fulfilling shipping requests to transport packages between origin and destination locations through the coordinated interactions of distributed shipping assets that include service drones and service stations. The service drones are inclusive of delivery drones for holding and transporting packages and charge drones that carry additional power capacities and which are adapted to interact with delivery drones for executing power renewal routines for providing additional power to the power units of delivery drones. The service stations include docking stations that serve as a shelter for housing one or more service drones, provide additional power capacities and which are adapted to interact with service drones for executing power renewal routines for providing additional power to the power units of delivery drones and charge drones, provide software updates to the service drones, and perform maintenance and cleaning of service drones. The service stations are also inclusive of the transfer stations and storage stations disclosed in U.S. Pat. No. 9,975,651, U.S. patent application Ser. No. 15/949,791, and U.S. patent application Ser. No. 15/821,266, the entire content and disclosure each of which are hereby incorporated by reference. The system is further inclusive of a delivery server that manages the several shipping assets in the autonomous system.

The delivery server is adapted to communicate with one or more networks for receiving shipping requests from a user devices that communicate with the delivery server through the network, and the delivery server is further adapted to communicate with the several service assets (service drones and service stations) for executing transport tasks for fulfilling received shipping requests. In operation, the delivery server receives shipping requests specifying an origin location for an initial package pick-up and a destination location for a final package drop-off, and generates a shipping agenda for retrieving the package from the origin location and transporting the retrieved package to the destination location. The shipping agenda will include the selection of at least one service drone and generation of a navigation route for the at least one service drone, and optionally the selection of at least one service station, if needed.

The delivery server will communicate with a delivery drone to assigns a transport task that may include at least one of: travelling to an origin location to retrieve a package; travelling over at least a portion of the distance between an origin location and a destination location for transporting a package therebetween, and travelling to a destination location to drop-off a package. The delivery will communicate with a charge drone to assign a transport task that includes travelling to waypoint location to meet with a delivery drone to execute a power renewal routine for providing additional power to the power unit of the delivery drone. When a shipping request requires the use of a service station, the delivery server will communicate with the necessary service stations to assign the corresponding tasks—e.g., a docking station for the storage or repowering of a service drone; a transfer station for the transfer of a package between two delivery drones; and a storage station for temporarily storing a package in mid-shipment.

When communicating with a delivery drone to assign a transport task, the delivery server will assess a current charge capacity of a power unit of that selected delivery drone to determine if the that delivery drone requires additional power in order to execute the assigned transport task. The delivery server may determine if a delivery drone requires additional power in order to execute an assigned transport task by comparing a current charge capacity of the delivery drone to a calculated charge capacity for the assigned transport task. The calculated charge capacity for an assigned transport task may be calculated, for example, from a travel distance between the current location of the delivery drone and the task location together with an estimated power-usage rate for the delivery drone to travel that distance based on historical data as to the drones power usage during normal travel conditions.

If the delivery server determines that the delivery drone does not require additional power, the delivery server instructs the delivery drone to travel along a first navigation route from its current location to a task location for execution of the assigned transport task. However if the delivery server determines that the delivery drone does require additional power, the delivery server instructs the delivery drone to travel along a second navigation route from its current location to a waypoint location at which the delivery drone will execute a power renewal routine to receive additional power, and then travel to the task location for execution of the assigned transport task.

A task location may be any location at which a delivery drone is instructed to perform a transport task. For example, a task location may be an origin location for executing initial package pick-up; a destination location for executing a final package drop-off; or a transfer site for executing a package transfer for exchanging a package with another delivery drone. The waypoint location for execution of a power renewal routine may be the location of any docking station in the shipping system, which is deemed to be within a predetermined distance from the navigation route for the assigned shipping task. Alternatively, the waypoint location for execution of a power renewal routine may be any location along the navigation route, or proximate thereto, that the delivery server may select as a meeting location for the delivery drone and a charge drone.

Power renewal routines are executed through mating power renewal units on the delivery drone and either a docking station or a charge drone, or through mating module transfer interfaces on the delivery drone and either a docking station or a charge drone. Power renewal units may include contact energy interfaces and wireless energy interfaces. Module transfer interfaces include removable power modules in the delivery drones that are stored in module chamber that are accessible through a module hatch, and mating module chambers on either a docking station or a charge drone that interact with the module chamber of a delivery drone to replace depleted power modules with charged power modules.

Service drones, including delivery drones and charge drones, may be provided in the form of ground drones and aerial drones, and the autonomous shipping system preferably includes both ground and aerial delivery drones as well as both ground and aerial charge drones. Power renewal routines between delivery drones and charge drones may executed while the two drones are in a parked position, or may be executed while the two drones are travelling along corresponding navigation routes. When executing a power renewal routine during travelling, the two drones may either be finely controlled to execute synchronized movements, without requiring a physical connecting between the drones, or the drones may instead be latched onto one another though mating engagement mechanisms.

With a distributed system of service assets that includes docking stations and charge drones with power renewal units for the execution of power renewal routines, an autonomous shipping system according to one aspect of the present invention is capable of instructing a delivery drone to acquire additional power by stopping at any docking station that is within a preset distance from a navigation route for an assigned transport task, or may instead meet with a charge drone along the navigation route itself. In this way, there is avoided the need for a delivery drone to depart from the navigation route, and the delivery drone may in fact recharge while travelling along the navigation route, thereby minimizing downtime and enhancing system uptime and overall efficiency.

### BRIEF DESCRIPTION OF THE DRAWINGS

Further features and advantages of the invention can be ascertained from the following detailed description that is provided in connection with the drawings described below:

FIG. 1 shows one example of an autonomous shipping system, and corresponding service region and service assets, according to one example of the present invention;

FIG. 2 shows a control system of a delivery server of the shipping system in FIG. 1;

FIGS. 3A and 3B show a ground delivery drone (GDD) of the shipping system in FIG. 1;

FIGS. 3C and 3D show a direct package transfer between two GDDs of FIGS. 3A-3B;

FIG. 4 shows a control system of the GDD in FIGS. 3A-3B;

FIGS. 5A and 5B show a ground charge drone (GCD) of the shipping system in FIG. 1;

FIG. 5C shows a power transfer routine executed between a GDD of FIGS. 3A-3B and a GCD of FIG. 5A-5B;

FIG. 6 shows a control system of the GCD in FIGS. 5A-5B;

FIGS. 7A and 7B show a docking station of the shipping system in FIG. 1;

FIG. 8 shows a control system of the docking station in FIGS. 7A-7B;

FIGS. 9A-9B show a transfer station of the shipping system in FIG. 1;

FIG. 10 shows a control system of the transfer station in FIGS. 9A-9B;

FIG. 11 shows a multi-unit station composed of multiple transfer stations in FIGS. 9A-9B;

FIGS. 12A-12C show a storage station of the shipping system in FIG. 1;

FIG. 13 shows a control system of the storage station in FIGS. 12A-12C;

FIG. 14 shows a multi-unit station composed of a transfer station in FIGS. 9A-9B and a storage station in FIGS. 12A-12C;

FIGS. 15-18 show one example of the logic steps executed by a delivery server in the shipping system in FIG. 1 in generating a shipping agenda; and

FIGS. 19-23 show one example of the logic steps executed by a delivery server in the shipping system in FIG. 1 in assigning transport tasks to shipping assets for the fulfillment of a shipping request.

### DETAILED DESCRIPTION OF THE INVENTION

The following discussion of the present invention is made relative to the examples shown in the accompanying drawings, though does not limit the invention to those examples.

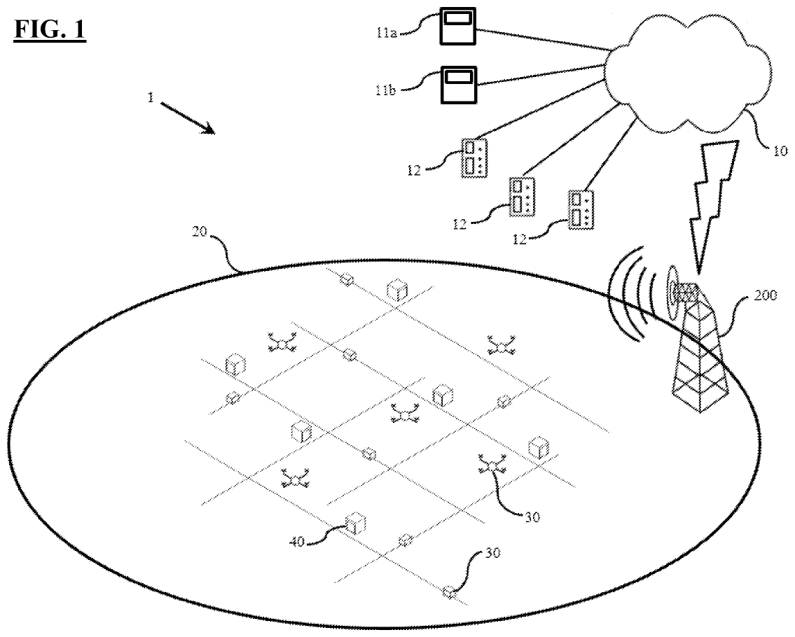

FIG. 1 shows one example of an autonomous shipping system 1 according to the invention. In this example, the system 1 includes a delivery server 200 that manages shipping services in a service region 20, and controls service drones 30 and service stations 40 within the service region. Service drones 30 controlled by the delivery server 200 may include ground drones such as unmanned ground delivery drones (GDDs) 300 and unmanned ground charge drones (GCDs) 400, as well as aerial drones such as unmanned aerial vehicles (UAVs) 500. Service stations 40 controlled by the delivery server 200 may include docking stations 600, transfer stations 700, storage stations 800 and combinations thereof (multi-unit stations 900).

The delivery server 200 communicates with a network 10 to receive shipping requests. Once a shipping request is received, the delivery server 200 processes the shipping request to generate a shipping agenda having a number of discrete transport tasks, then selects service assets (e.g., service drones 30 and service stations 40) for executing individual transport tasks for fulfillment of the shipping request, and then communicates with selected service assets to instruct execution of the transport tasks and to monitor performance of the individual shipping assets. The delivery server 200 may also provide software updates to all service assets downstream thereof, including, though not limited to service drones 30 and service stations 40.

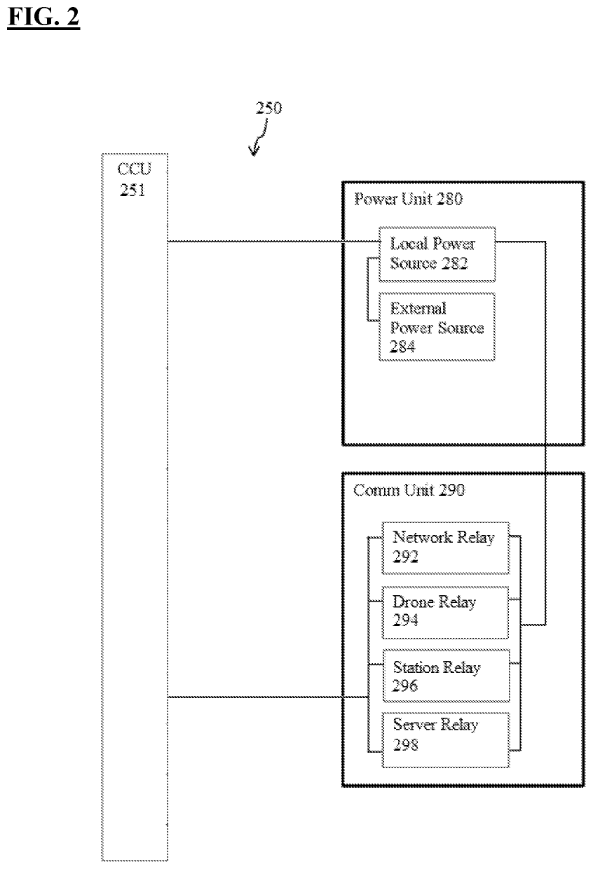

FIG. 2 shows one example of a control system 250 of the delivery server 200 that includes a central control unit (CCU) 251 that contains a memory for storing software applications and operational data, as well as a processor for executing applications and accessing operational data stored at the memory. The server control system 250 further includes a power unit 280 and a communications unit 290. Stored software applications and operational data may be updated manually at the delivery server 200 or through one or more communications relays.

Software and applications stored at the CCU 251 will include navigation software and applications for map-based navigation. Specifically, the CCU 251 will store a number of regional maps for the service region 20 and will routinely update those regional maps, for example, through communications with one or more external facilities 12 that operate as a mapping facility. Such external facilities 12 may generate mapping data from sources that may be a part from the shipping system 1, or which may be operated separately from the shipping system 1, such as ground nodes or satellite assets. The delivery server 200 may employ the locally stored maps for generating navigation routes for the various service drones 30 to traverse the service region 20 as needed for executing transport tasks for fulfilling shipping requests. The delivery server 200 may share the mapping data stored in the CCU 251 with the several service drones 30, with each drone storing the regional maps in the memory of its own CCU.

In addition to the regional mapping data acquired from the delivery server 200, the many downstream service drones 30 may also store navigation software and applications for the performance of localized navigation, whereby the service drone 30 may independently navigate in an unknown environment using its own sensors for recognizing and recording the presence of obstacles encountered in its environment and calculating the positions of those obstacles within the regional mapping data. A service drone 30 may generate and store its own localized mapping data in parallel with the regional mapping data obtained from the delivery server 200, or may use the localized mapping data to update the regional mapping data stored at the drones CCU. As a result, each individual service drone 30 may generate mapping data that is unique to that specific drone. The many service drones 30 may transfer localized mapping data upstream to the delivery server 200, and the delivery server 200 may employ the localized mapping data from the several different service drones 30 to update its own regional mapping data, and may then redistribute the updated regional mapping data back downstream to the several service drones 30. In this way, the shipping system 1 may use mapping data acquired from external facilities 12, but may also have a learning capability for generating and updating its own mapping data.

The communications unit 290 is used for sending and receiving signals for communicating with one or more networks 10, service drones 30 and service stations 40, and optionally one or more additional delivery servers 200. The communications unit 290 may be divided into separate communications relays, with each relay handling a separate communication type. For example, a network relay 292 may handle communications with and one or more networks 10; a drone relay 294 may handle communications with and one or more service drones 30; and a station relay 296 may handle communications with and one or more service stations 40. In examples where the shipping system 1 includes multiple delivery servers 200, the communications unit 290 may include a server relay 298 that handles communications with and one or more other delivery servers 200. In some examples, the communications relays may be further sub-divided into dedicated communications relays for asset-specific communications. For example, the drone relay 294 may be subdivided into a GDD relay that handles communications with one or more ground delivery drones 300; a GCD relay that handles communications with one or more ground charge drones 400; and a UAV relay that handles communications with one or more unmanned aerial vehicle drones 500. Similarly, the station relay 296 may be subdivided into a docking relay that handles communications with one or more docking stations 600; a transfer relay that handles communications with one or more transfer stations 700; and a storage relay that handles communications with one or more storage stations 800.

The power unit 280 includes a local power source 282, and optionally an external power source 284. The local power source 282 (e.g., a replaceable and/or rechargeable battery; a fuel-based power source; etc.) powers the server CCU 251 as well as any other components of the delivery server 200 that require electrical power to operate. The power unit 280 may also include one or more external power sources 284 adapted to electrically communicate with and recharge the local power source 282. Non-limiting examples of external power sources 284 may include solar panels, wind turbines, hydro turbines, kinetic energy transducers (e.g., for vibration energy conversion), electrical energy grids, fossil-fuel power sources, and combinations thereof.

The delivery server 200 communicates with one or more networks 10 through the network relay 292 to receive shipping requests. A network 10 may be any communications system that enables the exchange of information between a user device 11 and the delivery server 200 for conveying shipping requests and service messages (e.g., shipping confirmations, service alerts, etc.). A network 10 may also enable the exchange of information between one or more remote facilities 12 and the delivery server 200, including, though not limited to, facilities such as mapping facilities that update stored mapping data; software facilities that update stored software applications; and traffic monitoring systems that may provide continuous updates to traffic conditions. A network 10 may communicate with the delivery server 200 via wired or wireless communication links including, though not limited to, cable networks (e.g., telephone lines, television lines, internet lines, and other physical line connections); radio networks; cellular networks; satellite networks; etc. User devices 11 for sending shipping requests may be any device that communicate with a delivery server through a chosen communication link.

In operation, a user inputs a shipping request through a user device 11a that is linked with the delivery server 200 through a network 10. A shipping request will include at least a pick-up address and a drop-off address, and preferably additional specifics such as the size and weight of the package(s) to be delivered, identification information as to the sending and receiving entities, and transaction information for effecting payment for shipping services. The shipping request is transmitted to the delivery server 200 through the network 10. The delivery server 200 processes a received shipping request to identify an origin location (i.e., the initial pick-up location) and a destination location (i.e., a final drop-off location), and to generate a shipping agenda for transporting the package between the origin and destination locations. The delivery server 200 also performs route planning to select shipping assets (service drones 30 and service stations 40) for executing one or more transport tasks to fulfill the shipping request in accord with the shipping agenda. The delivery server 200 communicates with the selected shipping assets, monitors their performance in executing transport tasks and updates the shipping agenda and route planning as needed. For example, the delivery server 200 may monitor a service drone's travel and perform updated route planning as needed, such as in the event of changes in surrounding traffic (vehicle or foot traffic) or weather, a determination that the drone has gone off the planned navigation route or encountered an obstacle, or if it is determined that the service drone has an insufficient power capacity to complete an assigned transport task.

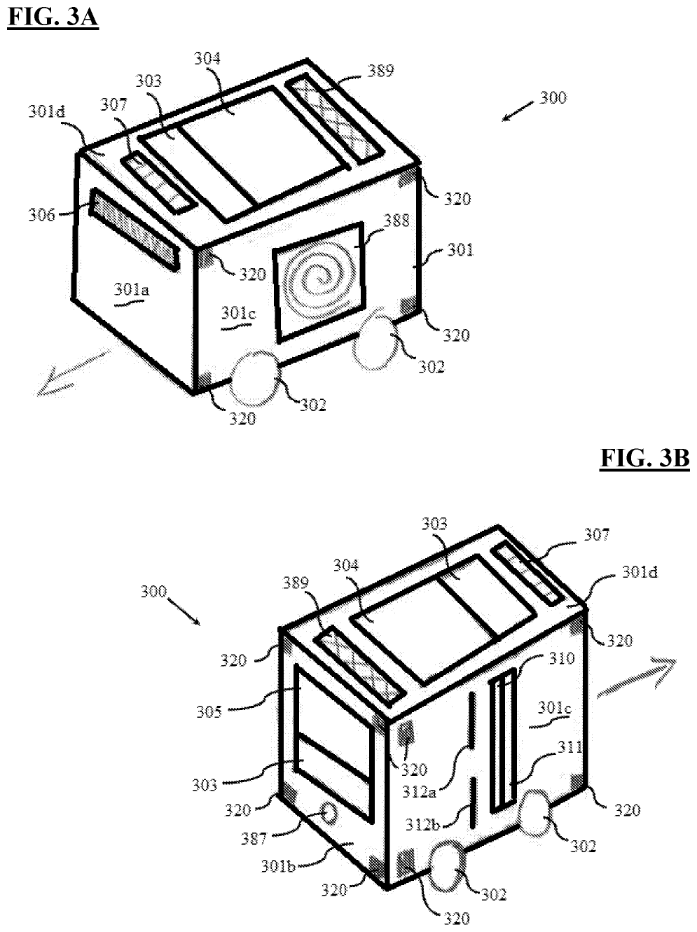

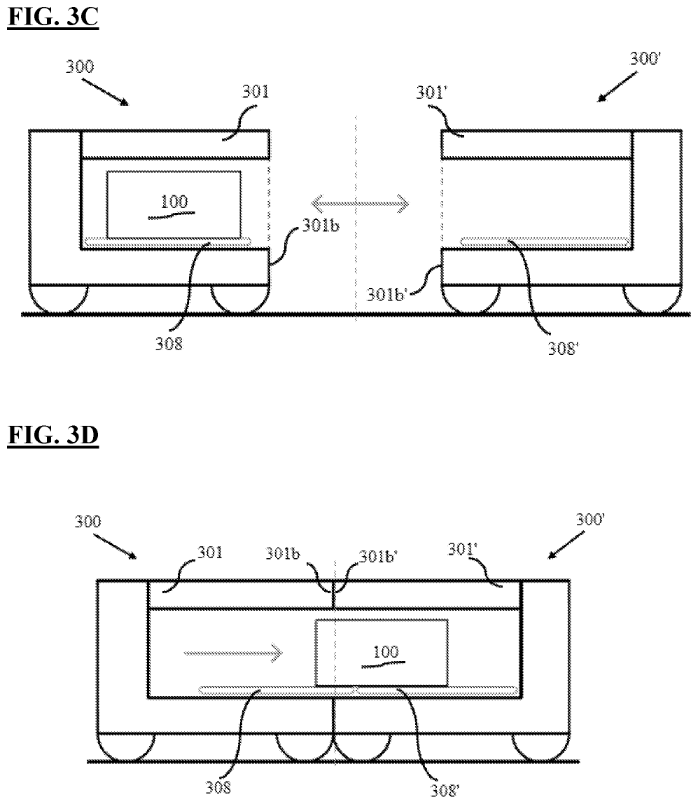

FIGS. 3A-3B illustrate one example of an unmanned ground delivery drone0 (GDD; i.e., a UGV that is operable as a delivery drone) according to the present invention. A GDD 300 communicates with the delivery server 200 to receive transport tasks and to convey a present energy capacity of the GDD power source. The delivery server 200 uses the information as to the present energy capacity of the GDD power source to determine whether the GDD 300 will require additional energy for completion of a transport task. If a determination is made that the GDD 300 requires additional energy, the delivery server 200 will provide instructions for the GDD to execute a power renewal routine. Transport tasks that may be assigned to a GDD 300 include, though are not limited to, travelling to an origin location to perform a package pick-up, travelling to a destination location to perform a package drop-off, and interacting with other shipping assets (service drones 30 and service station 40) to execute either a power renewal routine or a package transfer routine. Packages for transport by a GDD 300 may be inserted into and removed from the GDD either by a manual interaction between a user and the GDD 300, or through an automated interaction in which a service station 40 or another service drone 30 effects a package exchange with the GDD 300.

The GDD 300 includes a vehicle body 301 having a front 301a, a rear 301b, and two sides 301c. The GDD 300 has a plurality of wheels 302 and at least one internal holding space 303 for holding a package. Preferably, a specialized removable container 100 will be provided in the holding space 303, and packages to be transported by the GDD 300 will be placed within the container 100. In the example shown in FIGS. 3A-3B, the holding space 303 is accessible through both a top passage secured by a top hatch 304 and a rear passage secured by a rear hatch 305. A navigation sensor array 306 is provided at the front 301a of the vehicle body 301 for receiving information as to the surrounding environment of the drone for use in navigation. In some examples, the GDD 300 may include a separate sensor array at the front, rear and each side of the vehicle body 301, so as to enable a complete 360° sensory field. In other examples, the GDD 300 may have a single 360° sensor array mounted to a top 301d of the vehicle body 301.

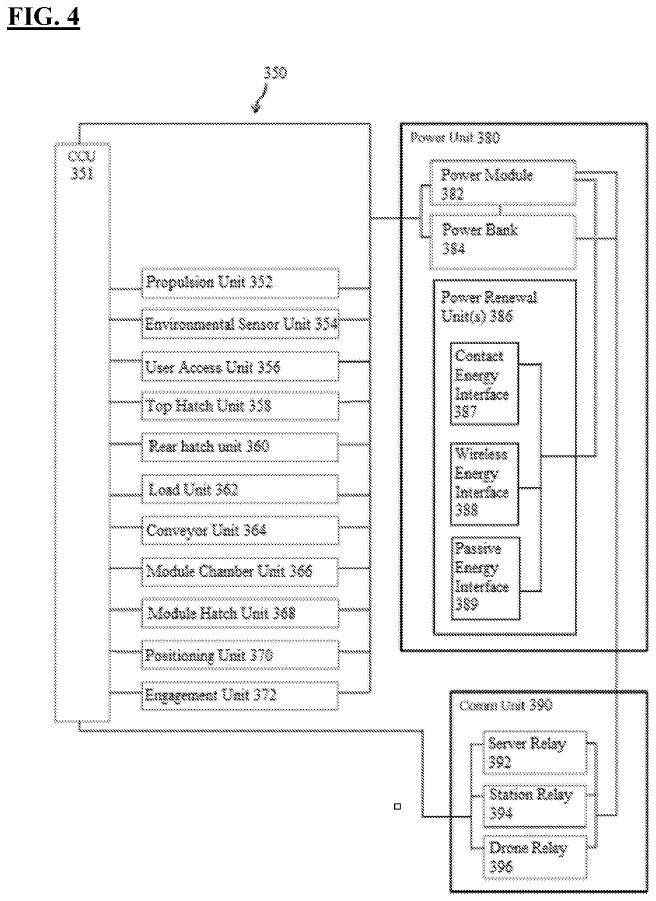

FIG. 4 shows one example of a control system 350 of a GDD 300 that includes a central control unit (CCU) 351 that includes a memory for storing software applications and operational data, as well as a processor for executing applications and accessing operational data stored at the memory. Stored software applications and operational data may be updated through one or more communications relays. As discussed previously, the GDD CCU 351 will include navigation software and applications for map-based navigation as well as localized navigation, and the mapping data stored at the CCU 351 may be updated both through communications with the delivery server 200 and via a learning capacity from localized navigation software and applications—and the GDD 300 may also communicate with the delivery server 200 to provide updated mapping data to the delivery server 200 based on information learned from the localized navigation software and applications. The GDD control system 350 further includes a propulsion unit 352; an environmental sensor unit 354; a user access unit 356; a top hatch unit 358; a rear hatch unit 360; a load unit 362; a conveyor unit 364; a module chamber unit 366; a module hatch unit 368; a positioning unit 370; an engagement unit 372; a power unit 380; and a communications unit 390.

The communications unit 390 is used for sending and receiving signals for communicating with one or more delivery servers 200; one or more service stations 40; and one or more other service drones 30. The communications unit 390 may be divided into separate communications relays, with each relay handling a separate communication type. For example, a server relay 392 may handle communications with one or more delivery servers 200; a station relay 394 may handle communications with one or more service stations 40; and a drone relay 396 may handle communications with one or more other service drones 30. In some examples, the communications relays may be further sub-divided into dedicated communications relays for component specific communications. For example, the station relay 394 may be subdivided into a docking relay that handles communications with one or more docking stations 600; a transfer relay that handles communications with one or more transfer stations 700; and a storage relay that handles communications with one or more storage stations 800. Similarly, the drone relay 396 may be subdivided into a GDD relay that handles communications with one or more ground delivery drones 300; and a GCD relay that handles communications with one or more ground charge drones 400.

The propulsion unit 352 includes one or more propulsion devices, such as one or more electric motors, that are configured to receive power from the power unit 380, generate a drive force, and output generated drive force to the wheels 302 for propelling the GDD 300. The propulsion unit 352 also includes a steering system that receives signals from the CCU 351 for executing turning of the wheels 302 so as to direct the GDD 300 along a navigation route.

The environmental sensor unit 354 includes a number of environmental sensors that monitor and receive information as to the surrounding environment of the GDD 300. The environmental sensors are exposed through the environmental sensor array 306, and may include, without limitation: one or more GPS transceivers; one or more video sensors; one or more motion sensors; one or more image sensors; one or more pressure sensors; one or more ultrasonic sensors; and one or more infrared sensors. The various environmental sensors send signals to the CCU 351, which interprets those signals with the aid of applications and algorithms stored at the CCU memory so as to assess the surrounding environment and determine appropriate actions for navigating the GDD 300 and for executing interactions between the GDD and the environment.

The user access unit 356 includes a manually or remotely manipulable user interface 307 that is operable by users for opening the top hatch 304 to insert and remove packages from the holding space 303. Examples of user interfaces 307 include, without limitation: physical locking mechanisms (e.g., key-and-lock devices; combination locks, etc.); manual input devices (e.g., touch keys, touchscreens, etc.); scanning devices (e.g., bar-code, fingerprint, and facial scanners, etc.); and secure wireless communication devices (e.g., RFID sensors; smart-device communications systems, etc.). The user access unit 356 is configured to output signals to the CCU 351 confirming successful manipulation of the user interface 307, with the CCU 351 then outputting signals to the top hatch unit 358 instructing opening of the top hatch 304.

The top and rear hatch units 358/360 each include one or more motors that receive signals from the CCU 351 instructing opening and closing of the respective hatches 304/305. These hatch units 358/360 may also include one or more hatch sensors that detect positioning of the respective hatches 304/305 (e.g., opened, closed, or intermediate positions thereof), and/or which may detect the presence of an obstruction in the movement path thereof (e.g., an oversized or improperly inserted container, a UAV drone suspension system, a service station actuator mechanism, a GDD conveyor, etc.); and which output signals to the CCU 351 indicating the positioning of the respective hatches 304/305 and/or an obstruction state of a hatch movement path (e.g., obstructed, not obstructed).

The load unit 362 determines the load state of the GDD holding space 303, and outputs a signal to the CCU 351 indicating a load state. The CCU 351 may use the load state of the GDD holding space 303 to determine next steps in operation of the GDD 300 (e.g., opening or closing the top or rear hatches 304/305; communicating with a delivery server 200 to convey availability for assignment of a transport task; etc.).

The conveyor unit 364 includes one or more conveyor motors that receive signals from the CCU 351 for driving a conveyor belt 308 that is positioned within the holding space 303 to move a container 100 for repositioning within the holding space 303 and/or effecting package transfer through the rear opening secured by the rear hatch 305 (e.g., as in a GDD-GDD direct package transfer). In some examples, the conveyor belt 308 may be built on a platform that is horizontally movable such that the conveyor belt 308 may be moved horizontally to protrude through the rear opening of the GDD vehicle body 301 when the rear hatch 305 is in an open position. In examples where the conveyor belt 308 is horizontally moveable, the conveyor unit 364 will include one or more additional conveyor motors that receive signals from the CCU 351 instructing horizontal movement of the driving a conveyor belt 308 between a retracted position in which it is fully contained within the holding space 303, and an extended position in which it protrudes from the holding space 303 through the rear opening of the vehicle body 301. In such examples, the conveyor unit 364 may also include one or more conveyor belt sensors that detect positioning of the conveyor belt 308 (e.g., retracted, extended, or intermediate positions thereof), and which output signals to the CCU 351 indicating the positioning of the conveyor belt 308.

The power unit 380 includes a power module 382, a power bank 384, and one or more power renewal units 386. The power module 382 is a rechargeable and/or removable power source that serves as the primary power source supplying electrical energy for operation of the several components of the control system 350, as well as other mechanisms of the GDD 300. The power bank 384 serves as a back-up redundancy to the power module 382, in the event the power module 382 is depleted or otherwise unable to supply adequate power. When the CCU 351 determines the power module 382 is depleted, and when there is not adequate power supply available from another source (e.g., a power renewal unit 386), the CCU 351 may instruct the power unit 380 to switch power demands to the power bank 384. In examples where the power module 382 is removable and replaceable, the power bank 384 may operate to supply necessary energy for continuing operation of the GDD 300 while the power module 382 is removed. Preferably, the power bank 384 is rechargeable from one or both of the power module 382 and the one or more power renewal units 386, with the CCU 351 prioritizing charging of the power bank 384 so as to ensure adequate storage of back-up energy in the event of an energy loss from the power module 382.

In the example shown in FIGS. 3A-3B and 4, the power module 382 is rechargeable through power renewal units 386—which in this example includes a contact energy interface 387; a wireless energy interface 388; and a passive energy interface 389. In other examples, the GDD 300 may be provided with any number and combination of separate power renewal units 386. In some examples, the GDD 300 may not have any power renewal units 386, and may instead rely solely on removal and replacement of power modules 382 for effecting power renewals to the power unit 380.

The contact energy interface 387 is a physical electrical connection adapted for receiving electrical energy from a corresponding contact energy interface provided either on another service drone 30 (e.g., a GCD 400) or at a service station 40 (e.g., a docking station 600). Examples of contact energy interfaces 387 include, though are not limited to, mating electrical sockets and plugs; mating electrical plates and slip brushes, and combinations thereof. In the example shown in FIGS. 3A-3B, the GDD 300 is provided with a female contact energy interface 387 in the form of an electrical socket for reception of a mating male contact energy transfer interface in the form of an electrical plug. Though this example illustrates the contact energy interface 387 at the rear 301b of the vehicle body 301, it may instead be located at any other surface (including the front, either side, the top, or the bottom thereof).

The wireless energy interface 388 is a wireless electrical connection adapted for receiving electrical energy from a corresponding wireless energy interface provided either on another service drone 30 (e.g., a GCD 400) or at a service station 40 (e.g., a docking station 600). Examples of wireless energy interfaces 388 include, though are not limited to, mating pairs of energy transmitters and receivers for transferring electrical energy via inductive or capacitive coupling, power beaming, and combinations thereof. Though the example shown in FIGS. 3A-3B illustrates the wireless energy interface 388 at a side 301c of the vehicle body 301, it may instead be located at any other surface (including the front, the rear, the top, or the bottom thereof).

The passive energy interface 389 is an interface that converts energy from a natural renewable energy source into electrical energy. Examples of passive energy interfaces include solar panels, wind turbines, kinetic transducers, and combinations thereof. Though the example shown in FIGS. 3A-3B illustrates the passive energy interface 389 at a top 301d of the vehicle body 301, it may instead be located at any other surface (including the front, the rear surface, either side surface, or the bottom thereof), provided the particular type of renewable energy may be adequately accessed from such surface.

Optionally, the power module 382 of the GDD 300 shown in FIGS. 3A-3B and 4 may be removable and replaceable through a side passage in the vehicle body 301 that opens to a module chamber 310 in in which the removable power module 382 is stored. The side passage is secured by a module hatch 311, and is dimensioned to permit passage of power modules 382 therethrough, so as to enable extraction of a depleted power module 382 and insertion of a charged power module 382 in place thereof. Power module replacement may be performed through an interaction between the GDD 300 and another service drone 30 (e.g., a GCD 400) or a service station 40 (e.g., a docking station 600). Power module transfers between the GDD 300 and a GCD 400 may be performed with the two drones stopped, or with the two drones moving in synchronization with one another. Though the example shown in FIGS. 3A-3B illustrates the side passage being positioned at a side 301c of the vehicle body 301, it may instead be located at any other surface (including the front, the rear, the top, or the bottom thereof).

In examples where the GDD 300 is provided with a removable power module 382, the vehicle body 301 may also be provided with one or more engagement mechanisms 312 adapted to interact with one or more mating engagement mechanisms 412 on a GCD 400 for locking the two drones into predefined positions relative to one another so as to ensure proper alignment of the drones for extraction and insertion of power modules 382, as well as to ensure synchronized movements and continued proper alignment of the drones when executing a power module exchange while the drones are moving. An engagement mechanism 312 may be provided in the form of mating pairs of locking engagement slots and extendable engagement arms, with one drone having an engagement arm that is extendable from the vehicle body and the other drone having an engagement slot for reception and locking of the engagement arm of the other drone. To enhance a secure locking of two drones it is preferable each drone have at least two engagement mechanisms, such as a fist passage housing an extendable engagement arm and a second passage in the form of an engagement slot. In the example shown in FIG. 3B, the GDD 300 is provided with a lower passage 312b housing an extendable engagement arm and an upper passage 312a in the form of an engagement slot, so as to facilitate secure engagement with a GCD 400 that has a lower passage 412b in the form of an engagement slot and an upper passage 412a housing an extendable engagement arm. Engagement mechanisms may also be provided in other forms, such as mating pairs of electromagnets that are selectively powered between on and off states for engaging and disengaging two drones; and multiple types and combinations of engagement mechanisms may be provided on a single drone. Though the example shown in FIGS. 3A-B illustrates the engagement mechanisms 312 at a side 301c of the vehicle body 301, they may instead be located at any other surface (including the front, the rear, the top, or the bottom thereof), provided they are positioned to enable engagement of two drones in proper alignment for executing transfer of a power module 382 through the opening that is secured by the module transfer hatch 311.

The module chamber unit 366 includes one or more sensors for detecting the presence or absence of a power module 382 in the module chamber 310, and which may output signals to the CCU 351 indicating the presence or absence of a power module 382. The module chamber unit 366 may also include one or more module locking mechanisms that receive signals from the CCU 351 for securing and releasing a locked state of a power module 382 that is present within the module chamber 310.

The module hatch unit 368 includes one or more module hatch motors that receive signals from the CCU 351 to open and close the module transfer hatch 311, as well as one or more module hatch sensors that detect positioning of the module transfer hatch 311 (e.g., opened, closed, or intermediate positions thereof), and/or the presence of an obstruction in a movement path of the module transfer hatch (e.g., an improperly positioned power module, presence of an extendable arm, etc.); and which output signals to the CCU 351 indicating the positioning of the module transfer hatch and/or an obstruction state of the transfer hatch movement path (e.g., obstructed, not obstructed).

The positioning unit 370 includes one or more positioning sensors 320 that detect nearby objects for executing fine movements and positioning of the GDD 300. The positioning sensors 320 may also perform short-range communications with corresponding positioning sensors provided on other drones and/or service stations for assessing movement and positioning of the GDD 300 relative thereto. The positioning sensors transmit signals to the CCU 351 conveying positioning information, and the CCU 351 uses that information to control the propulsion unit 352 to effect fine movements of the GDD 300, for example, when positioning the GDD 300 relative to either a service station 40 or another service drone 30 for effecting either a package transfer or a power renewal routine. In examples where the GDD 300 is provided with environmental sensor arrays on multiple surfaces to enable a complete 360° sensory field, or where the navigation software of the CCU 351 is alone capable of achieving sufficiently fine maneuvering and positioning, the GDD 300 may forego the positioning unit 370 and positioning sensors 320.

The engagement unit 372 includes one or more engagement hatch motors that receive signals from the CCU 351 to open and close engagement hatches for each engagement mechanism 312 provided on the GDD 300, as well as one or more engagement hatch sensors that detect positioning of each engagement hatch (e.g., opened, closed, or intermediate positions thereof), and/or the presence of an obstruction in a movement path of each engagement hatch (e.g., an extendable engagement arm, etc.); and which output signals to the CCU 351 indicating the positioning of the engagement hatches and/or an obstruction state of the engagement hatch movement paths (e.g., obstructed, not obstructed). Engagement units 312 in the form of an extendable engagement arm further include one or more engagement arm motors that receive signals from the CCU 351 to extend and retract each engagement arm, as well as one or more engagement arm sensors that detect an extension state of the engagement arm (e.g., extended, retracted) and an engagement state of each engagement arm (e.g., engaged, disengaged) and which output signals to the CCU 351 indicating the extension and engagement states of the engagement arm. Engagement units in the form of a locking engagement slot further include one or more engagement lock motors that receive signals from the CCU 351 to lock and unlock a received engagement arm, as well as one or more engagement lock sensors that detect the presence of an engagement arm in the engagement slot and an engagement state of the engagement slot (e.g., locked, unlocked, engagement, disengaged) and which output signals to the CCU 351 indicating a reception and engagement state of the engagement slot. Engagement units in the form of an electromagnetic lock include one or more actuators that receive signals from the CCU 351 to power-on and power-off the electromagnet, as well as one or more sensors that detect the powered state of the electromagnet (e.g., power-on, powered-off) and/or an engagement state of the electromagnet (e.g., engaged or disengaged from a mating electromagnet), and which output signals to the CCU 351 indicating the power and engagement states thereof.

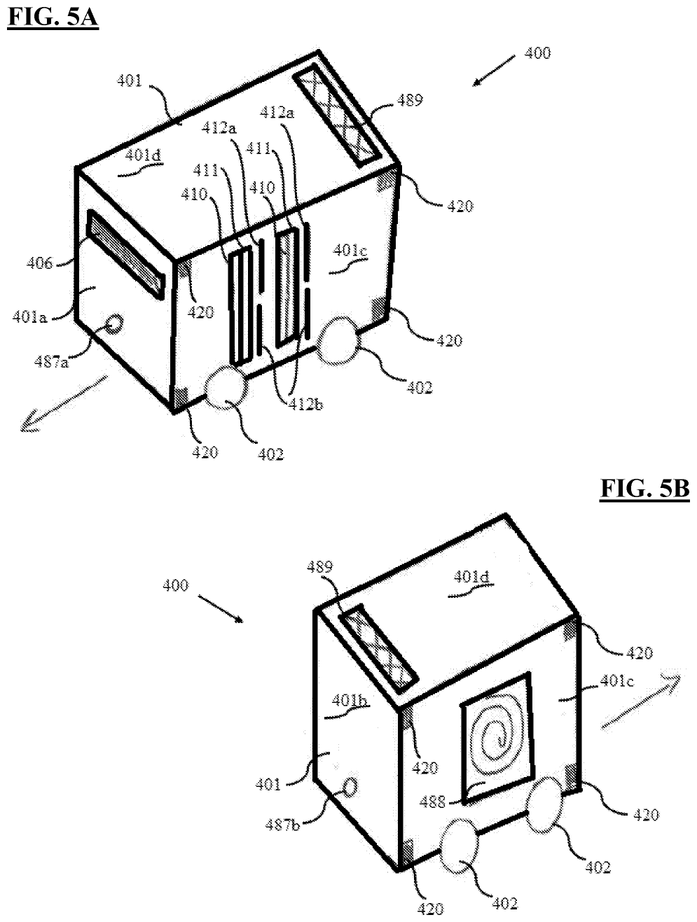

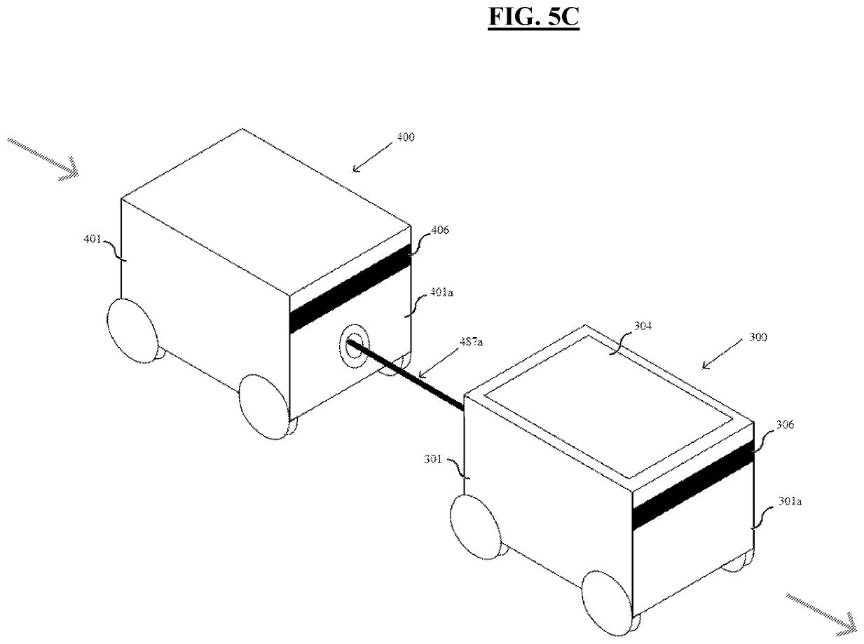

FIGS. 5A-5B illustrate one example of an unmanned ground charge drone 400 (GCD; i.e., a UGV drone operable as a charge drone) according to the present invention. A GCD 400 communicates with a delivery server 200 to receive transport tasks for executing power renewal routines with GDDs 300 that are in need of additional energy. The GCD 400 also communicates with the delivery server 200 to convey the present energy capacities of power modules 382 stored in the GCD 300 as well as the charge capacity of the GCD power source. The delivery server 200 uses the present charge capacity of the GCD power source to determine if the GCD 400 has sufficient energy capacity to service a GDD 300 and whether the GCD 400 itself requires additional energy. If a determination is made that a GDD 300 requires additional energy, the delivery server 200 will assign a transport task to the GCD 400, requiring the GCD 400 to travel to a waypoint to meet with a target GDD 300 that requires additional energy and to execute a power renewal routine with the GDD 300.

The GCD 400 includes a vehicle body 401 having a front 401a, a rear 401b, and two sides 401c, and a plurality of wheels 402. A navigation sensor array 406 is provided at the front 401a of the vehicle body 401 for receiving information as to the surrounding environment of the GCD 400 for use in navigation. In some examples, the GCD 400 may include a separate sensor array at the front, rear and each side of the vehicle body 401, so as to enable a complete 360° sensory field. In other examples, the GCD 400 may have a single 360° sensor array mounted to a top 401d of the vehicle body 401.

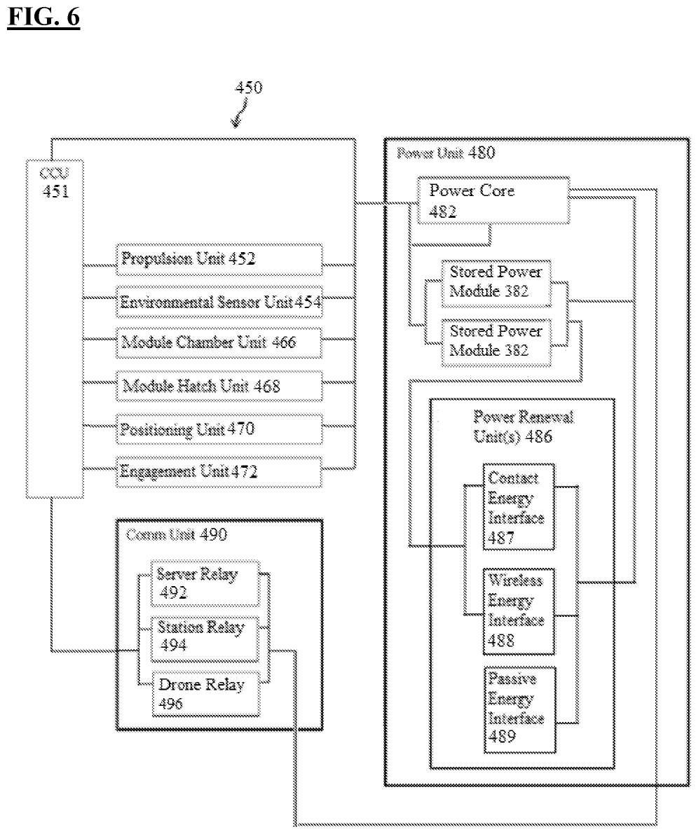

FIG. 6 shows one example of a control system 450 of a GCD 400 that includes a central control unit (CCU) 451 that is inclusive of a memory for storing software applications and operational data, and a processor for executing applications and accessing operational data stored at the memory. Stored software applications and operational data may be updated through one or more communications relays. As discussed previously, the GCD CCU 451 will include navigation software and applications for map-based navigation as well as localized navigation, and the mapping data stored at the CCU 451 may be updated both through communications with the delivery server 200 and via a learning capacity from localized navigation software and applications—and the GCD 400 may also communicate with the delivery server 200 to provide updated mapping data to the delivery server 200 based on information learned from the localized navigation software and applications. The GCD control system 450 further includes a propulsion unit 452; an environmental sensor unit 454; a module chamber unit 466; a module hatch unit 468; a positioning unit 470; an engagement unit 472; a power unit 480; and a communications unit 490.

The communications unit 490 is used for sending and receiving signals for communicating with one or more delivery servers 200; one or more service stations 40; and one or more other service drones 30. The communications unit 490 may be divided into separate communications relays, with each relay handling a separate communication type. For example, a server relay 492 may handle communications with one or more delivery servers 200; a station relay 494 may handle communications with one or more service stations 40; and a drone relay 496 may handle communications with one or more other service drones 30. In some examples, the communications relays may be further sub-divided into dedicated communications relays for component specific communications. For example, the station relay 494 may be subdivided into a docking relay that handles communications with one or more docking stations 600; a transfer relay that handles communications with one or more transfer stations 700; and a storage relay that handles communications with one or more storage stations 800. Similarly, the drone relay 496 may be subdivided into a GDD relay that handles communications with one or more ground delivery drones 300; and a GCD relay that handles communications with one or more ground charge drones 400.

The propulsion unit 452 includes one or more propulsion devices, such as one or more electric motors that are configured to receive power from the power unit 480, generate a drive force, and output generated drive force to the wheels 402 for propelling the GCD 400. The propulsion unit 452 also includes a steering system that receives signals from the CCU 451 for executing turning of the wheels 402 so as to direct the GCD 400 along a navigation route.

The environmental sensor unit 454 includes a number of environmental sensors that monitor and receive information as to the surrounding environment of the GCD 400. The environmental sensors are exposed through the environmental sensor array 406, and may include, without limitation: one or more GPS transceivers; one or more video sensors; one or more motion sensors; one or more image sensors; one or more pressure sensors; one or more ultrasonic sensors; and one or more infrared sensors. The various environmental sensors send signals to the CCU 451, which interprets those signals with the aid of applications and algorithms stored at the CCU memory so as to assess the surrounding environment and determine appropriate actions for navigating the GCD 400 and for executing interactions between the GCD 400 and the environment.

The power unit 480 includes a power core 482 and one or more power renewal units 486. Any power modules 382 that are currently stored in the GCD 400, for exchange with GDD's 300, will also be connected with the power unit 480. The power core 480 is a rechargeable power source that serves as the primary power source supplying electrical energy for operation of the several components of the control system 450, as well as other mechanisms within the GCD 400. The power core 482 is rechargeable via electrical energy received from the power renewal units 486. In the example shown in FIGS. 5A-5B and 6, the GCD 400 has three power renewal units 486—a contact energy interface 487; a wireless energy interface 488; a passive energy interface 489. In other examples, the GCD 400 may be provided with any number and combination of separate power renewal units 486, and may be provided without any power renewal units.

The contact energy interface 487 is a physical electrical connection adapted for exchanging electrical energy with a corresponding contact energy interface provided either on a service drone 30 (e.g., a GDD 300) and/or at a service station 40 (e.g., a docking station 600). Examples of contact energy interfaces 487 include, though are not limited to, mating electrical sockets and plugs; mating electrical plates and slip brushes, and combinations thereof. In the example shown in FIGS. 5A-5B, the GCD 400 is provided with a first contact energy interface 487a in the form of a male electrical plug that is extendable and retractable from an internal housing for insertion into a corresponding contact energy interface 387 in the form of a female electrical socket, such as that of the GDD 300. The GCD 400 in this example is also provided with a second contact energy interface 387b in the form of a female electrical socket for reception of a corresponding contact energy interface in the form of a male electrical plug, such as that of another service drone 30 or at a service station 40. Though this example illustrates the first contact energy interface 487a at the front 401a of the vehicle body 401, and the second contact energy interface 487b at the rear 401b of the vehicle body 401, they may instead be located at any other surface (including either side surface, the top, or the bottom thereof), and may be located on a common surface with one another. Also, though the example in FIGS. 5A-5B includes two separate contact energy interfaces 487a/487b for mating with separate types of corresponding contact energy interfaces, with the first contact energy interface adapted to transmit energy and the second contact energy interface adapted to receive energy, in other examples the GCD 400 may have a single contact energy interface that is alone adapted to transmit and receive energy (e.g., a universal electrical interface with an internal switch for changing current flow).

The wireless energy interface 488 is a wireless electrical connection adapted for exchanging electrical energy with a corresponding wireless energy interface provided either on service drone 30 (e.g., a GDD 300) or at a service station 40 (e.g., a docking station 600). Examples of wireless energy interfaces 488 include, though are not limited to, mating pairs of energy transmitters and receivers for transferring electrical energy via inductive or capacitive coupling, power beaming, and combinations thereof. The wireless energy interface 488 is operable to switch between a first energy transfer mode in which it transmits electrical energy to a corresponding wireless energy interface (e.g., in a GCD-to-GDD recharge routine) and a second energy transfer mode in which it receives electrical energy from a corresponding wireless energy interface (e.g., as in a service station-to-GCD recharge routine). Though the example shown in FIGS. 5A-5B illustrates the wireless energy interface 488 at a side 401c of the vehicle body 401, it may instead be located at any other surface (including the front, the rear surface, the top surface, or the bottom thereof).

The passive energy interface 489 is an interface that converts energy from a natural renewable energy source into electrical energy. Examples of passive energy interfaces include solar panels, wind turbines, kinetic transducers, and combinations thereof. Though the example shown in FIGS. 5A-5B illustrates the passive energy interface 489 at the top 401d of the vehicle body 401, it may instead be located at any other surface (including the front, the rear, either side, or the bottom thereof), provided the particular type of renewable energy may be adequately accessed from such surface.

As shown in FIG. 6, when the GCD 400 is storing removable power modules 382, for exchange with GCD's 300, the stored power modules 382 will be held within module chambers 410 that are each accessible by a corresponding side passage secured by a corresponding module hatch 411. The side passages are dimensioned to permit the passage of power modules 382 therethrough, so as to enable ejection and reception of the removable power modules 382. Power module exchanges may be performed through an interaction of the GCD 400 with either a service drone 30 (e.g., a GDD 300) or a service station 40 (e.g, a docking station 400). Power module exchanges between the GCD 400 and a GDD 300 may be performed with the drones stopped, or with the drones moving in synchronization with one another. Though the example shown in FIGS. 5A-5B illustrates the module chambers being accessible by passages located at a side 401c of the vehicle body 401, they may instead be accessible through openings located at any other surface (including the front, the rear, the top, or the bottom thereof). Also, though the example shown in FIGS. 5A-5B is shown with only two module chambers 410, a GCD 400 according to the present invention may be provided with any number of module chambers 410, with the size of the vehicle body 401 made to accommodate the number of desired module chambers 410.

In examples where the GCD 400 is provided with one or more side passages for exchanging removable power modules 382 in module chambers 410, the GCD 400 may also be provided with one or more engagement mechanisms 412 adapted to interact with one or more mating engagement mechanisms 312 on a GDD 300 for locking the two drones into predefined positions relative to one another so as to ensure proper alignment of the drones for extraction and insertion of power modules, as well as to ensure synchronized movements and continued proper alignment of the drones when executing such power module exchanges while the drones are moving. An engagement mechanism 412 may be provided in the form of mating pairs of locking engagement slots and extendable engagement arms, with one drone having an engagement arm that is extendable from the vehicle body 401 and the other drone having an engagement slot for reception and locking of the engagement arm. To enhance a secure locking of two drones it is preferable each drone have at least two engagement mechanisms 412, such as a fist passage housing an extendable engagement arm and a second passage in the form of an engagement slot. For example, the GCD 400 in FIGS. 5A-5B may be provided with a lower passage 412b in the form of an engagement slot and an upper passage 412a housing an extendable engagement arm, so as to facilitate secure engagement with a GDD 300 which may be provided with a lower passage 312b housing an extendable engagement arm and an upper passage 312a in the form of an engagement slot. Engagement mechanisms may also be provided in other forms, such as mating pairs of electromagnets that are selectively powered between on and off states for engaging and disengaging two drones; and multiple types and combinations of engagement mechanisms be provided on a single drone. Though the example shown in FIGS. 5A-5B illustrates the engagement mechanisms 412 at a side 401c of the vehicle body 401, they may instead be located at any other surface (including the front, the rear, the top, or the bottom thereof), provided they are positioned to enable engagement of two drones in proper alignment for executing a power module transfer through the openings that are secured by the module transfer hatches 411.

The module hatch unit 468 includes one or more module hatch motors that receive signals from the CCU 451 to open and close a module transfer hatch 411, as well as one or more module hatch sensors that detect positioning of the module transfer hatch 411 (e.g., opened, closed, or intermediate positions thereof), and/or the presence of an obstruction in a movement path of the module transfer hatch (e.g., an improperly positioned power module, presence of an extendable arm, etc.); and which output signals to the CCU 451 indicating the positioning of the module transfer hatch 411 and/or an obstruction state of the transfer hatch movement paths (e.g., obstructed, not obstructed).

The module chamber unit 466 includes one or more sensors for detecting the presence or absence of power modules 382 in the module chambers 410, and which may output signals to the CCU 451 indicating the presence or absence of power modules 382. The module chamber unit 466 of the GCD 400 further includes an extendable and retractable module transfer arm stored within each module chamber, with each transfer arm having a manipulator at the end thereof. One or more transfer arm motors are provided which receive signals from the CCU 451 for operating the module transfer arms to extend out through an open passage of a respective module chamber 410, and in through an open passage of a corresponding module chamber 310 in an aligned GDD 300, and which also operate the arm manipulator to grip an exposed surface of a power module 382 in the GDD module chamber 310, and to withdraw the transfer arm to extract the gripped power module 382 from the module chamber 310 of the GDD 300 and into the module chamber 410 of the GCD 400. The module transfer arm may include one or more manipulator sensors for detecting the presence or absence of a gripping surface of a power module 382 at the arm manipulator, and which may output signals instructing the transfer arm motors to activate the arm manipulators to grip the gripping surface. The module chamber unit 466 may also include one or more module locking mechanisms that receive signals from the CCU 451 for securing and releasing locked states of power modules 382 that are present within the module chambers 382.

The positioning unit 470 includes one or more positioning sensors 420 that detect nearby objects for assessing fine movements and positioning of the GCD 400. The positioning sensors 420 may also perform short-range communications with corresponding positioning sensors provided on other service drones 30 and/or service stations 40 for assessing movement and positioning of the GCD 400 relative thereto. The positioning sensors 420 transmit signals to the CCU 451 conveying positioning information, and the CCU 451 uses that information to control the propulsion unit 452 to execute fine movements for positioning the GCD 400, for example, relative to either a service station 40 or another service drone 30 for effecting a power renewal routine therebetween. In examples where the GCD 400 is provided with environmental sensor arrays on multiple surfaces to enable a complete 360° sensory field, or where the navigation software of the CCU 451 is alone capable of achieving sufficiently fine maneuvering and positioning, the GCD 400 may forego the positioning unit 470 and positioning sensors 420.

The engagement unit 472 includes one or more engagement hatch motors that receive signals from the CCU 451 to open and close engagement hatches for each engagement mechanism 412 provided on the GCD 400, as well as one or more engagement hatch sensors that detect positioning of each engagement hatch (e.g., opened, closed, or intermediate positions thereof), and/or the presence of an obstruction in a movement path of each engagement hatch (e.g., an extendable engagement arm, etc.); and which output signals to the CCU 451 indicating the positioning of the engagement hatches and/or an obstruction state of the engagement hatch movement paths (e.g., obstructed, not obstructed). Engagement units 412 in the form of an extendable engagement arm further include one or more engagement arm motors that receive signals from the CCU 451 to extend and retract each engagement arm, as well as one or more engagement arm sensors that detect an extension state of the engagement arm (e.g., extended, retracted) and an engagement state of each engagement arm (e.g., engaged, disengaged) and which output signals to the CCU 451 indicating the extension and engagement states of the engagement arm. Engagement units 412 in the form of a locking engagement slot further include one or more engagement lock motors that receive signals from the CCU 451 to lock and unlock a received engagement arm, as well as one or more engagement lock sensors that detect the presence of an engagement arm in the engagement slot and an engagement state of the engagement slot (e.g., locked, unlocked, engagement, disengaged) and which output signals to the CCU 451 indicating a reception and engagement state of the engagement slot. Engagement units 412 in the form of an electromagnetic lock include one or more actuators that receive signals from the CCU 451 to power-on and power-off the electromagnet, as well as one or more magnetic field sensors that detect the powered state of the electromagnet (e.g., power-on, powered-off) and/or an engagement state of the electromagnet (e.g., engaged or disengaged from a mating electromagnet), and which output signals to the CCU 451 indicating the power and engagement states thereof.

In operation, the primary purpose of the GCD 400 is to execute power renewal routines for performing either a recharging routine or a replacement routine with a GDD 300. Power renewal routines executed as replacement routines are performed by removing a depleted power module 382 from a GDD module chamber 310, storing the depleted module 382 in a first vacant module chamber 410 of the GCD 400, ejecting a charged power module 382 from a second module chamber of the GCD, and inserting the charged power module 382 in the module chamber 310 of the GDD 300. Power renewal routines executed as recharging routines are performed by establishing either a physical energy connection between a contact energy interface 487 of the GCD and a contact energy interface 387 of a GDD 300, or establishing a wireless energy connection between the wireless energy interface 488 of the GCD 400 and a wireless energy interface 388 of a GDD 300, and transferring electrical energy from the GCD 400 to the GDD 300 through the established connection.

As illustrated in FIG. 6, in each module chamber 410 that is available for storing a power modules 382, there is provided two electrical communication links for electrically connecting a stored power module 382 with the power renewal unit(s) 486. In the example shown, a first electrical communication link at each module chamber 410 will connect a stored power module 382 with only those specific power renewal units 386 that are operable for conveying electrical energy to a second service drone 30 (e.g., a GDD drone 300) in a power renewal routine—namely, the contact energy interface 487 and the wireless energy interface 488. With this first electrical communication link, power renewal routines performed through either the contact energy interface 487 or the wireless energy interface 488 may transmit electrical power that is drawn from one or more charged power modules 382 that are stored in one or more module chambers 410. In the illustrated example, the second electrical communication at each module chamber 410 will connect a stored power module 382 with each power renewal unit 386 that is operable for receiving electrical energy from an outside source (e.g., another service drone 30; a service station 40, or a natural energy source) in a power renewal routine—namely, the contact energy interface 487, the wireless energy interface 488 and the passive energy interface 489. With this second electrical communication link, the one or more power renewal units 486 may each be used to receive and transmit electrical energy for recharging one or more depleted power modules 382 that are stored in one or more module chambers 410. By providing each module chamber 410 with electrical communications such as the foregoing, the GCD 400 is thus capable of recharging any depleted power modules 382 that it may be storing after removal from another service drone (e.g., a GDD 300) without requiring the depleted power modules 382 to be removed from the GCD 400 for charging by a separate system—and the GCD 400 is also capable of using charged power modules 382 as electrical energy sources in executing a power renewal routine in the form of a recharging routine, thereby avoiding the need for the GCD 400 to draw electrical power from the GCD's own power core 482.

As also illustrated in FIG. 6, in each module chamber 410 that is available for storing a power modules 382, there may also be provided third and fourth electrical communication links that run between each module chamber 410 and the power core 482 or a power junction upstream of the power core 482. In the example shown, the third electrical communication link runs from each module chamber 410 directly to the power core 482 such that a power module 382 stored in a module chamber 410 may be used for recharging the power core 482. The fourth electrical communication link runs from each module chamber 410 to a power junction upstream of the power core 482, such that a stored power module 382 may operate as a back-up power source for supplying electrical energy in place of the power core 482 in the event of a failure at the power core 482.

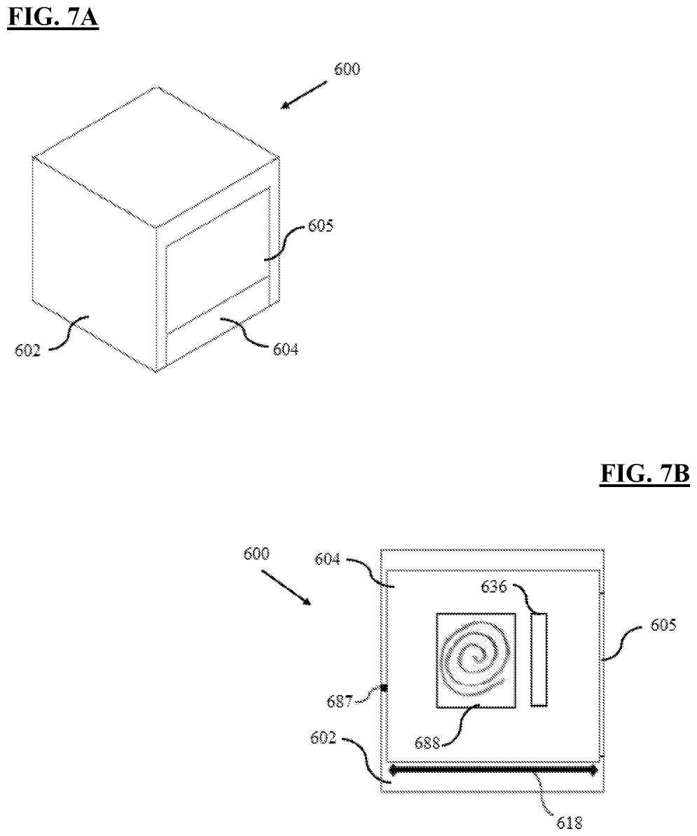

FIGS. 7A-7B show one example of a docking station 600 according to the present invention. The docking station 600 includes a housing 602 that defines an inner space 604, the housing 602 having a front door 606 that opens and closes a front passage between the inner space 604 and an outer environment. The front passage is dimensioned for a ground-based service drone 30 (e.g., a GDD 300 and/or a GCD 400) to pass therethrough for entering and exiting the inner space 604. The inner space 604 may be dimensioned to receive and fully enclose one or more service drones 30, and may receive multiple service drones of different types. A docking station 600 according to the present invention will house a service drone 30 that is awaiting a transport task assignment (e.g., a package transport task for a GDD 300, a power renewal task for a GCD 400, etc.) and/or which is actively executing a power renewal routine in coordination with the docking station 600.

The docking station 600 may be an independent, stand-alone structure or may form a part of another larger structure. When included as a part of another structure, the docking station 600 may include a second door that opens and closes a second passage to a second outer environment that differs from the outer environment outside the front door 606. For example, a docking station 600 may be provided in a building, such as a parking garage, a business or a residential dwelling, with the front door 606 opening to an environment outside the building and a second door opening to an internal space within the building.

The docking station 600 may include a guiding system 618 for guiding approaching service drones 30 through the front passage and to a predetermined position within the inner space 604. There may be a number of such predetermined positions within the inner space 604, including a single predetermined parking or storage space for a single service drone 30, or multiple such spaces for multiple service drones 30. The docking station 600 may also include one or more predetermined positions that are used for specific purposes, such as predetermined positions for aligning a service drone with drone cleaning or maintenance systems, and predetermined positions for aligning a service drone with a power renewal unit for execution of a power renewal routine.

The guiding system 618 may take a variety of forms provided it functions to reliably direct a service drone 30 to one or more predetermined positions. For example, in a simple arrangement, such as one where the docking station 600 receives only a single service drone at a time, the guiding system 618 may simply include a contoured floor surface, such as a sloped surface having tracks that lead to preset points where the wheels of the service drone 30 will come to rest, with a stopping structure at the preset points (e.g., divots or protrusions). In other examples, the guiding system 618 may include an automated conveyor or rail system, which may attach to a portion of the service drone and pull and/or push the drone to move it between one or more predetermined positions. In further examples, the guiding system 618 may include a localized positioning system (LPS) having a network of sensors, transmitters, and/or transceivers that determine the position of the service drone within the inner space 604 and communicate positioning information to a navigation system of the drone for use in autonomously navigating the drone to the predetermined position. A suitable guiding system 618 may also include a combination of two or more of the foregoing examples.

The housing 602 may be made of any material that is weather resistant. Non-limiting examples of materials suitable for constructing the housing 602 include metal, plastic, wood, glass, fiber glass, carbon fiber, and combinations thereof. The front door 606 may be made of any closure structure. Non-limiting examples of closure structures that may be used for the front door 606 include a single panel or object closure (e.g., a moving plate), a multiple panel or object closure (e.g., a series of hinged panels, or a series of plates or bars), and combinations thereof. The panel(s) and/or object(s) making up the front door 606 may be made of any material offering a suitable degree of protection and durability. In some examples, the docking station 600 may omit a front door 606 such that the front passage is always in an open state.

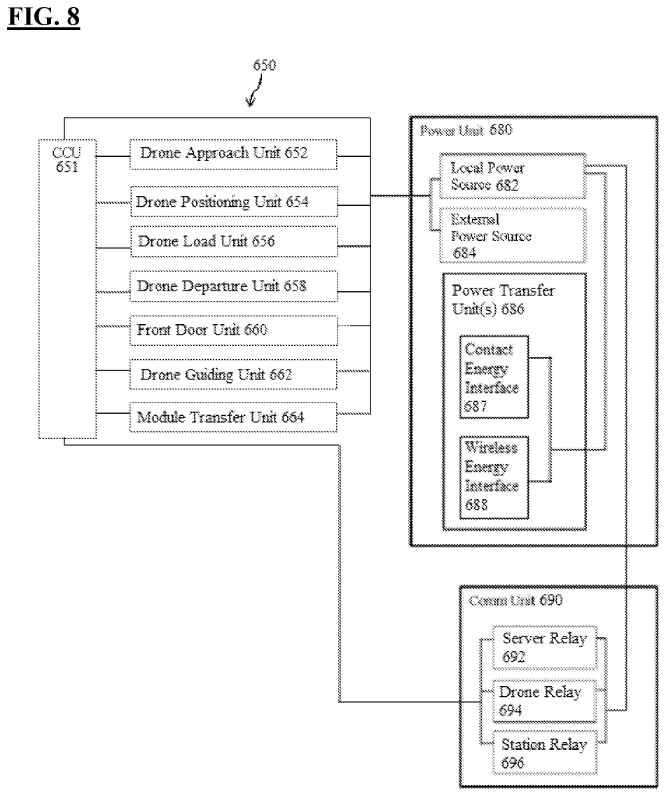

FIG. 8 shows one example of a control system 650 for a docking station 600 that includes a central control unit (CCU) 651 that is inclusive of a memory for storing software applications and operational data, as well as a processor for executing applications and accessing operational data stored at the memory. Stored software applications and operational data may be updated through one or more communications relays. The docking station control system 650 further includes a drone approach unit 652; a drone positioning unit 654; a drone load unit 656; a drone departure unit 658; a front door unit 660; a drone guiding unit 662; a module transfer unit 664; a power unit 680; and a communications unit 690.

The communications unit 690 is used for sending and receiving signals for communicating with one or more delivery servers 200; one or more service drones 30; and one or more other service stations 40. The communications unit 600 may be divided into separate communications relays, with each relay handling a separate communication type. For example, a server relay 692 may handle communications with one or more delivery servers 200; a drone relay 694 may handle communications with one or more service drones 30; and a station relay 696 may handle communications with one or more other service stations 40. In some examples, the communications relays may be further sub-divided into dedicated communications relays for component specific communications. For example, the drone relay 694 may be subdivided into a GDD relay that handles communications with one or more GDDs 300; and a GCD relay that handles communications with one or more GCDs 400. Similarly, the station relay 696 may be subdivided into a docking relay that handles communications with one or more other docking stations 600; a transfer relay that handles communications with one or more transfer stations 700; and a storage relay that handles communications with one or more storage stations 800.

A front door unit 660 may include one or more front door motors that receive signals from the CCU 651 for the opening and closing of the front door 606. The front door unit 660 may also include one or more front door sensors that detect positioning of the front door 606 (e.g., opened, closed, or intermediate positions thereof), and/or which may detect the presence of an obstruction in the front door movement path (e.g., a UGV, a bystander, wildlife, etc.); and which output signals to the CCU 651 indicating the positioning of the front door 606 and/or an obstruction state of the front door movement path (e.g., obstructed, not obstructed).

A drone approach unit 652 may include one or more approach sensors for detecting the approach of a service drone 30 relative to the docking station 600, and for outputting a signal to the CCU 651 indicating that a drone is approaching the docking station.

A drone positioning unit 654 may include one or more positioning sensors for determining both that one or more service drones 30 are within the inner space 604 of the housing 602 and whether the drones are located at predetermined positions therein, and for outputting a signal to the CCU 651 indicating positioning of the drones, which may include positing information indicating whether the drones are parked at predetermined positions, and/or localized positioning data indicating relative positioning of the drones in relation to one or more predetermined positions in the inner space 604 of the docking station 600. Positioning information received at the CCU 651 may then be transmitted to individual service drones 30 within the docking station 600 through signals exchanged between communications units of the docking station 600 and the individual service drones 30.

A drone load unit 656 may include one or more load sensors for determining load states of one or more service drones 30 parked in the housing 602, which may include the presence or absence of a loaded container 100 in GDDs 300 and/or the presence or absence of depleted/charged power modules 382 in GCDs 400, and for outputting signals to the CCU 651 indicating load states of service drones 30. Preferably, drone load sensors also detect changes in load states of drones, and output signals to the CCU 651 indicating load state changes—which may be indicative that a container 100 has been removed or loaded into a GDD 300, or that one or more power modules 382 have been removed or loaded into a GCD 400, or even that a previously depleted power module 382 in a GCD 400 has been recharged. In some examples, load states of service drones 30 may be assessed by load units of the drones themselves, and communicated to the docking station 600 via the exchange of signals between communications units.

A drone departure unit 658 may include one or more drone departure sensors for detecting the departure of service drones 30 from docking station 600, and for outputting signals to the CCU 651 indicating when a drone has departed the station.

In examples where the docking station 600 includes a drone guiding system 618 in the form of an automated conveyor or rail system, the control system 650 may include a drone guiding unit 662 that includes one or more guiding motors for engaging a service drone 30 and for driving the automated conveyor or rail system to move an engaged drone, and which receive signals from the CCU 651 instructing engagement of a drone and/or movement of an engaged drone via the automated conveyor or rail system. The drone guiding unit 662 may further include one or more guide sensors for detecting the presence of a service drone 30 within proximity for engagement by the drone guiding system 618, and for outputting signals to the CCU 651 indicating the same.

The power unit 680 of the docking station 600 may include a local power source 682 (e.g., a replaceable and/or rechargeable battery; a fuel-based power source; etc.) that powers the CCU 651 as well as any other components of the docking station 600 that require electrical power. Optionally, the power unit 680 may communicate with one or more external power sources 684 for charging the local power source 682. Non-limiting examples of external power sources 684 may include solar panels, wind turbines, hydro turbines, kinetic energy transducers (e.g., for vibration energy conversion), electrical energy grids, fossil-fuel power sources, and combinations thereof. The docking station 600 may be constructed in any suitable place for making use of the chosen power source—e.g., at an area of unobstructed sunlight for extracting solar energy; at an area of prominent wind flow for extracting wind energy from wind turbines; near a waterway to extract hydro energy from hydroelectric turbines; etc.

Power transfer unit(s) 686 may be provided for establishing an electrical communication for transferring electrical energy between the power unit 680 and power units of service drones 30 such that the local power source 682 may charge the drone power units through execution of a power renewal routine. A power transfer unit 686 may take the form of a contact energy interface 687 and/or a wireless energy interface 688.

A contact energy interface 687 is a physical electrical connection adapted for transmitting electrical energy to a corresponding contact energy interface provided on a service drone 30 (e.g., a GDD 300, a GCD 400, etc.). Examples of contact energy interfaces 687 include, though are not limited to, mating electrical sockets and plugs; mating electrical plates and slip brushes, and combinations thereof. In the example shown in FIG. 7B, the docking station 600 is provided with a contact energy interface 687 in the form of a male electrical plug that is extendable and retractable from an internal housing for insertion into a corresponding contact energy interface in the form of a female electrical socket, such as those of the GDD 300 in FIG. 3B (387) and the GCD 400 in FIG. 5B (487). Though this example illustrates the contact energy interface 687 at a rear wall of the docking station 600, it may instead be located at any other surface (including a side wall, a floor, or a ceiling thereof).

The wireless energy interface 688 is a wireless electrical connection adapted for transmitting electrical energy to a corresponding wireless energy interface provided on a service drone 30 (e.g., a GDD 300, a GCD 400, etc.). Examples of wireless energy interfaces 688 include, though are not limited to, mating pairs of energy transmitters and receivers for transferring electrical energy via inductive or capacitive coupling, power beaming, and combinations thereof. Though the example shown in FIG. 7B illustrates the wireless energy interface 688 at a side wall of the docking station 600, it may instead be located at any other surface (including a rear wall, a floor, or a ceiling thereof).

In some examples a power transfer unit 686 may be exposed for engagement by a service drone 30 without any advance electrical power requirement by the docking station 600, and the power source of a service drone 30 (upon engaging the power transfer unit 686) may serve as the sole power source for operation of the docking station 600, without requiring a local power source 682. For example, the docking station 600 may be constructed without any front door 606, such that a service drone 30 may navigate into the inner space 604 and engage the power transfer unit 686. In another example, the power transfer unit 686 may take the form of a power receiving structure that extends between a point outside of the docking station 600, ahead of the front door 606, to a point in the inner space 604 of the docking station housing 602 (e.g., an overhead electrical wire; an underside electrical rail or plate; etc.), and a service drone 30 may have a power conveying structure (e.g., an overhead electrical bar or surface; a underside electrical slip brush; etc.) that engages the power receiving structure at a location external of the docking station 600, such that the drone may engage the power transfer unit 686 to deliver operational power upon approaching the docking station 600. In some examples, a power transfer unit 686 may permit a service drone 30 to recharge the local power source 682 of the docking station 600 as a back-up redundancy to one or more external power sources 684 that serve as the primary power delivery of electrical power for the local power source 682.

The module transfer unit 664 includes a module transfer interface 636 having one or more passages that lead to module chambers for the reception and conveyance of power modules 382. The module transfer interface 636 is operable to remove depleted power modules 382 from a module chamber of a service drone 30 (e.g., a chamber 310 in a GDD 300, a chamber 410 in a GCD 400, etc.) and insert a charged power module 382 in place thereof. The module transfer interface 636 includes one or more module transfer arms having manipulators at the end thereof, and one or more transfer arm motors that receive signals from the CCU 651 for operating the module transfer arms to extend in to a module chamber in a service drone 30, operate the arm manipulator to grip an exposed surface of a depleted power module 382 in the module chamber, and withdraw the transfer arm to extract a gripped power module 382 from the module chamber. The one or more module transfer arms are likewise operable to receive signals from the CCU 651 for operating the module transfer arms to insert a charged power module 382 into a module chamber in a service drone, operate the arm manipulator to release the inserted power module 382, and withdraw the transfer arm. The module transfer arm may include one or more manipulator sensors for detecting the presence or absence of a gripping surface of a power module 382 at the arm manipulator, and which may output signals instructing the transfer arm motors to activate the arm manipulators to grip the gripping surface. Though the example shown in FIG. 7B illustrates the module transfer interface 636 positioned at a side wall of the docking station 600, it may instead be located at any other surface (including a rear wall, a floor, or a ceiling thereof).

In operation, upon detecting an approaching service drone 30 within proximity to the docking station 600, the drone approach unit 652 outputs a signal to the CCU 651, and the CCU 651 outputs a signal instructing the front door unit 660 to open the front door 606. Once the drone positioning unit 654 determines the service drone 30 has fully entered the inner space 604 of the station housing 602, and outputs a signal to the CCU 651 indicating the same, the CCU 651 then outputs a signal instructing the front door unit 660 to close the front door 606.

When entering the inner space 604, the guiding system 618 will guide a service drone 30 to a predetermined position. In examples where the docking station 600 includes an automated guiding system 618 (e.g., an automated conveyor or rail system), a drone guiding unit 662 may output a signal to the CCU 651 when there is detected the presence of the drone within proximity for engagement by the guiding system 618; and the CCU 651 may then output signals to the guiding unit 662 instructing the engagement and driving of the drone to a predetermined position. Once the drone positioning unit 654 determines the drone is at a predetermined position, the drone positioning unit 654 will output a signal to the CCU 651 confirming the same.

The drone load unit 656 determines the load state of the service drone 30, and outputs a signal to the CCU 651 indicating the load state of the drone, and the CCU 651 then instructs the communications unit 690 to transmit a signal to the delivery server 200 to update the status of the docking station 600 as housing that service drone 30, and indicating the load state of that drone.

Upon determining that a docking station 600 has a service drone 30 parked therein, and upon assessing the load state of the drone as well as the status of any transport tasks that are in need of execution, the delivery server 200 may output a signal instructing the service drone 30 to depart the docking station 600. For example, if the docking station 600 is housing a GDD 300 that is determined to have vacancy in its holding space 303 permitting reception of a package, then the delivery server 200 may instruct that GDD 300 to depart the docking station 600 to execute a package pick-up. Alternatively, if the docking station 600 is housing a GCD 400 loaded with one or more charged power modules 382, then the delivery server 200 may instruct that GCD 400 to depart the docking station 600 to execute a power renewal task.

When instructing the departure of a service drone 30 from a docking station 600, a delivery server 200 may also communicate with the docking station 600 via the communications unit 690 to instruct departure of the drone Upon receiving instructions that a service drone 30 is to depart the docking station 600, the CCU 651 will output a signal instructing the front door unit 660 to open the front door 606, and the drone may then depart the housing 602 under its own power or with assistance of the drone guiding system 618.

Once the drone departure unit 658 determines that a service drone 30 has fully exited the housing 602, the drone departure unit 658 will output a signal to the CCU 651 indicating the same; and the CCU 651 will output a signal instructing the front door unit 660 to close the front door 606. The CCU 651 may then instruct the communications unit 690 to transmit a signal to the delivery server 200 to update the status of the docking station 600 to indicate the service drone 30 has exited and/or the newly available capacity of the docking station 600 for receiving an alternate drone.

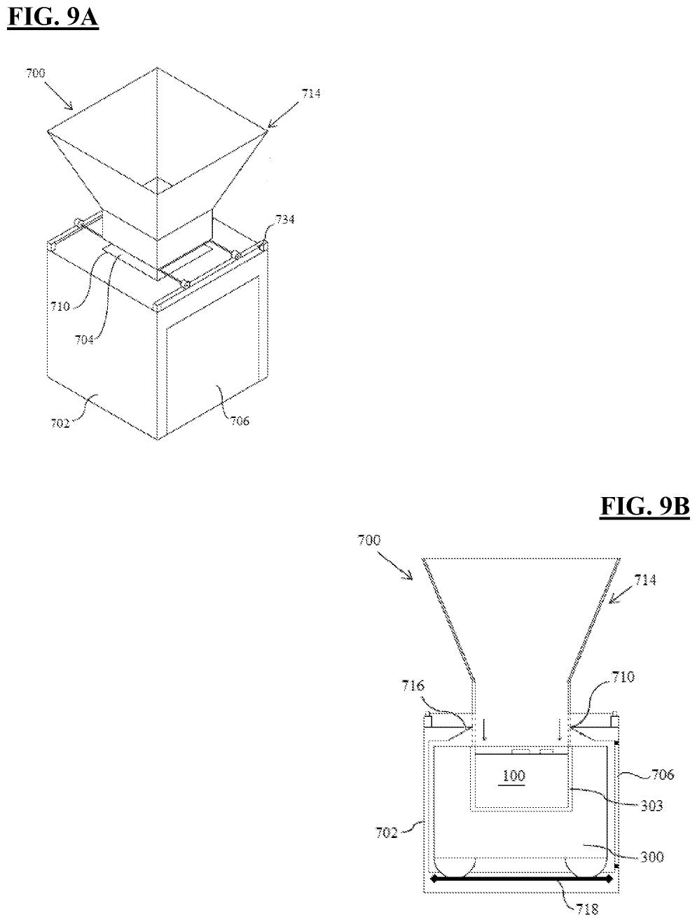

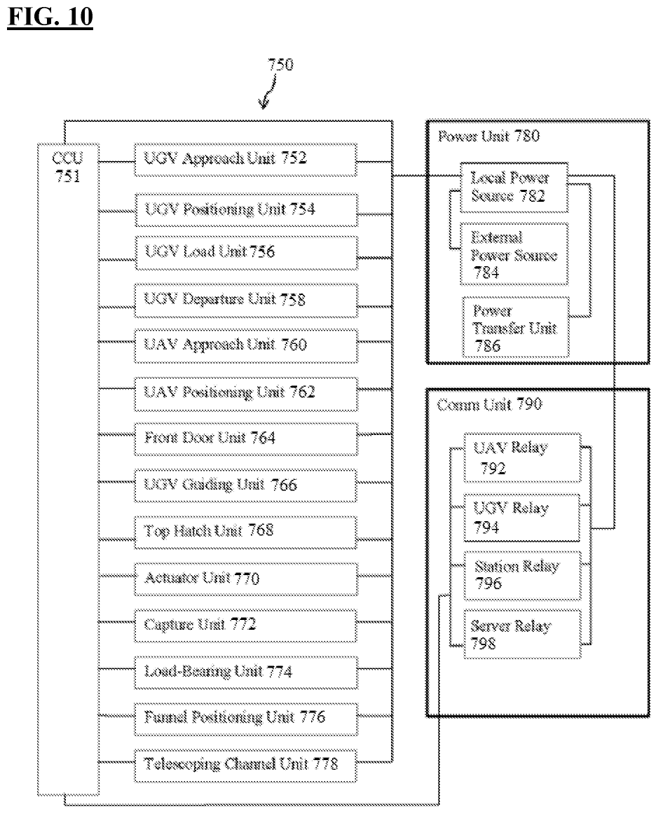

FIGS. 9A-9B show one example of a transfer station 700 according to the present invention, and FIG. 10 shows one example of a control system 750 for such a transfer station 700. The transfer station 700 includes a housing 702 that defines an inner space 704; the housing 702 having a front door 706 that opens and closes a first front passage between the inner space 704 and an outer environment, and a top hatch 710 that opens and closes a second top passage between the inner space 704 and an outer environment. A downwardly tapering funnel 714 is supported above the housing 702 on a track 734, and an upwardly tapering funnel 716 is provided within the housing 702. An actuating system is provided within the downwardly tapering funnel 714 that is operable for interacting with a capture system of a container 100 so as to selectively engage and disengage the container 100 to and from a UAV suspension system when executing container transfers to transfer a container 100 between the holding spaces of a UAV 500 and a GDD 300. Further details as to the transfer station 700 are provided in U.S. Pat. No. 9,975,651 and U.S. patent application Ser. No. 15/949,791, the entire content and disclosure both of which are hereby incorporated by reference.

The transfer station control system 750 includes a central control unit (CCU) 751 that is inclusive of a memory for storing software applications and operational data, as well as a processor for executing applications and accessing operational data stored at the memory. Stored software applications and operational data may be updated through one or more communications relays. The control system 750 further includes a GDD (UGV) approach unit 752; a GDD (UGV) positioning unit 754; a GDD (UGV) load unit 756; a GDD (UGV) departure unit 758; a UAV approach unit 760; a UAV positioning unit 762; a front door unit 764; a UGV guiding unit 766; a top hatch unit 768; an actuator unit 770; a capture unit 772; a load-bearing unit 774; a funnel positioning unit 776; a telescoping unit 778; a power unit 780; and a communications unit 790. The power unit 780 may further include a local power source 782; an external power source 784; and a power transfer unit 786. The communications unit 790 may further include a UAV relay 792; a GDD (UGV) relay 794; a station relay 796 and a server relay 798. Further details as to the transfer station control system 750 are provided in in U.S. Pat. No. 9,975,651 and U.S. patent application Ser. No. 15/949,791, the entire content and disclosure both of which are hereby incorporated by reference.

A transfer station 700 according to the present invention executes package transfers between GDDs and UAVs (GDD-UAV transfers), which includes transferring a package-carrying container 100 held in a GDD holding space to UAV holding space, and vice versa. Transfer stations 700 may be used, for example, to fulfill long distance shipping requests, with a first transfer station 700 proximate to the origin location serving to transfer a package-carrying container 100 between a first GDD 300 and a UAV 500, and a second transfer station 700 proximate to the destination location serving to transfer the package-carrying container 100 from the UAV 500 to a second GDD 300. In this way, the first GDD 300 may be assigned a transport task of retrieving a package from the origin location and transporting the package to first transfer station 700; the UAV 500 may be assigned a transport task of retrieving the package from the first GDD 300 at the first transfer station 700 and then transporting the package over a long distance portion of the shipment route between the first and second transfer stations, and the second GDD 300 may be assigned a transport task of retrieving the package from the UAV 500 at the second transfer station 700 and then travelling and delivering the package to the destination location. Such a GDD-UAV-GDD transfer sequence may also be used in fulfilling short distance shipment requests if it is determined that such a hybrid shipment method would in fact be quicker or otherwise more efficient than a ground-only shipment method via a GDD 300 alone, such as when there is a high traffic status or other complication in ground travel (e.g., construction, street closures, etc.).

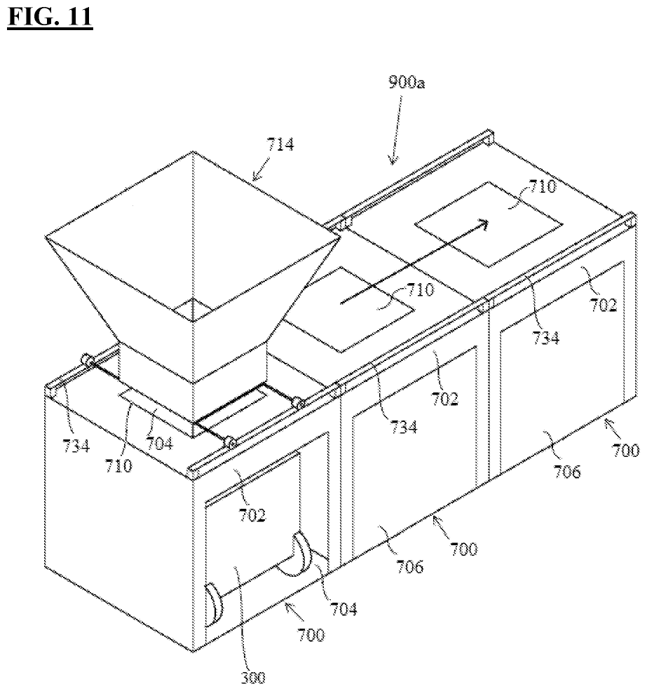

FIG. 11 show one example of a multi-unit service station 900a according to the present invention, in which multiple modular transfer stations 700 are positioned side-by-side. Each modular station 700 may be constructed in similar fashion to the transfer station 700 in FIGS. 9A-9B, with the exception that the several modular stations 700 are aligned to cooperate with one another and share a funnel 714 that moves between the separate stations 700 by travelling along tracks 734 that extend along the upper surfaces of each modular station 700 in alignment with one another. Further details as to multi-unit service stations 900a composed of several transfer stations 700 are provided in in U.S. Pat. No. 9,975,651 and U.S. patent application Ser. No. 15/949,791, the entire content and disclosure both of which are hereby incorporated by reference.

A multi-unit service station 900a composed of several transfer stations 700 may be used at any location that a singular transfer station 700 could be placed, though will normally be reserved for high volume locations so as to facilitate performance of a greater number of transfers. Such a multi-unit transfer station 900a may also be used to facilitate transfers between a first GDD and a second GDD, without a UAV (GDD-GDD transfers), which includes transferring a container 100 held in a holding space 303 of a first GDD 300 in a first modular transfer station 700 to a holding space 303 of a second GDD 300 in a second modular transfer station 700. A multi-unit transfer station 900a such as that shown in FIG. 11 may be used to perform GDD-GDD transfers if it is determined that such a shipment method would in fact be quicker or otherwise more efficient than a single GDD shipment method, such as when two portions of the shipment route have different terrains requiring two GDDs 300 of different locomotive types—e.g., as when a first portion of the shipment route will be along paved terrain navigable by road-wheel type GDD300, while a second portion of the shipment route will be along a sand or snow terrain requiring a continuous-tread type GDD 300, or a water terrain requiring flotation-device type GDD 300.

When a delivery server 200 determines that a transfer station 700 (singular or multi-unit) will assist in fulfilling a shipping request, the delivery server 200 communicates with the transfer station 700 to provide identifying information as to a specific service drone 30 (GDD 300 or UAV 500) that is assigned to drop-off a specific package-carrying container 100 at the transfer station 700 and as to a specific service drone 30 (GDD 300 or UAV 500) that is assigned to pick-up the specific package-carrying container 100 at the transfer station 700. In some instances, the container 100 may also have identifying information associated therewith (e.g., a printed barcode or other computer readable designation), and the delivery server 200 may also communicate identifying information as to the specific container 100 that is to be exchanged between the two identified drones. The transfer station 700 stores the identifying information received from the delivery server 200 in the memory of the CCU 751. Subsequently, when a service drone 30 approaches the transfer station 700, the transfer station exchanges communication signals with the drone to receive identifying information as to the specific drone and cross-references that information with the information stored at the CCU 751 to confirm the identity of the drone and the specific container 100 that is to be exchanged with that drone, thereby ensuring proper exchange of correct containers 100 between corresponding service drones 30.

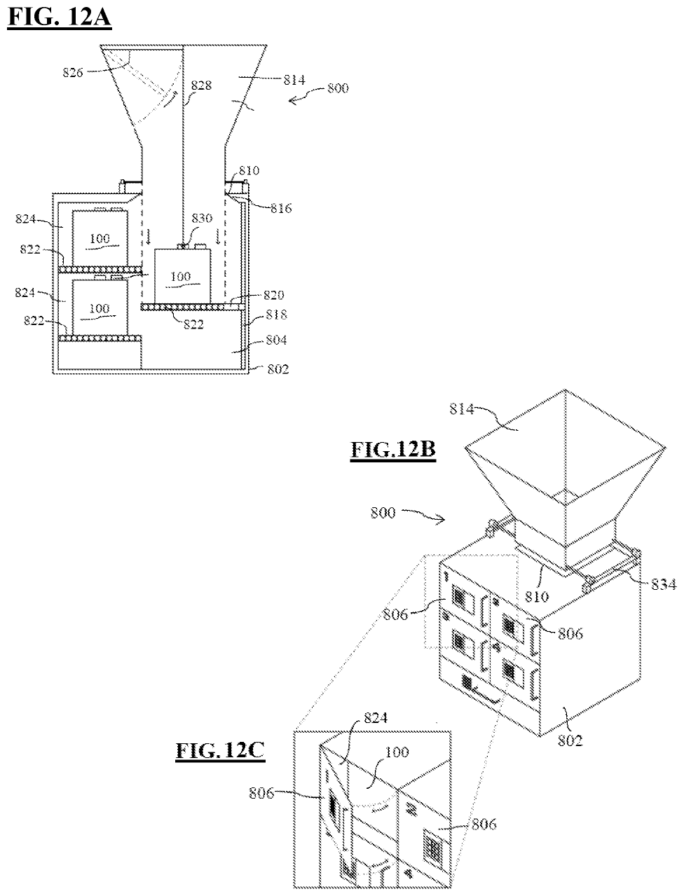

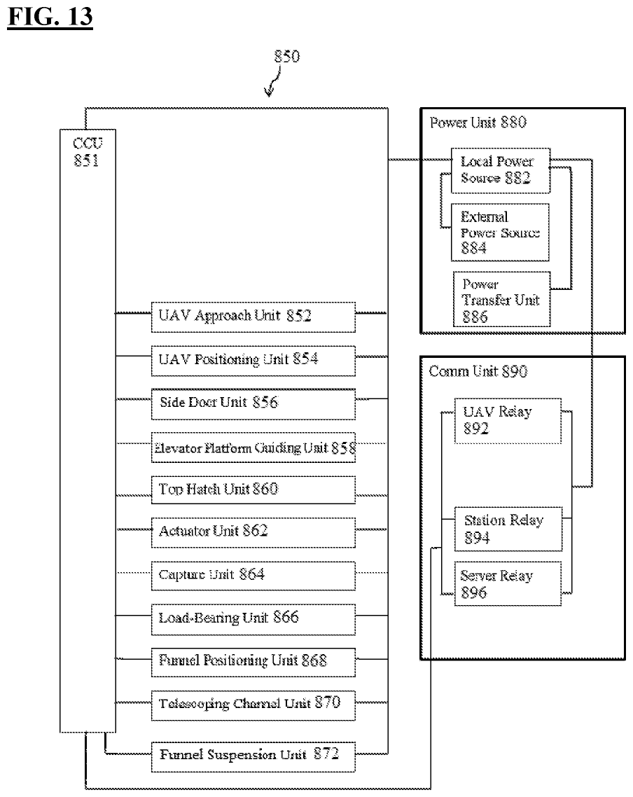

FIGS. 12A-12B show one example of a storage station 800 according to the present invention, and FIG. 13 shows one example of a control system 850 for such a storage station 800. The storage station 800 includes a housing 802 that defines an inner space 804; the housing 802 has side doors 806 that open and close side passages between the inner space 804 and an outer environment, and a top hatch 810 that opens and closes a top passage between the inner space 804 and an outer environment. Within the inner space 804, the storage station 800 includes an elevator platform guiding system 818, an elevator platform 820 and a number of conveyor belts 822 for receiving and moving a number of containers 100 into and out of a number of storage compartments 824. A downwardly tapering funnel 814 is supported above the housing 802 on a track 834, and an upwardly tapering funnel 816 is provided within the housing 802. Within the downwardly tapering funnel 814, there is provided a funnel suspension system that includes an extendable arm 826 and an extendable and retractable cable 828 having a load-bearing element 830 at an end thereof. The extendable arm 826 is moveable between a stowed position in which it is stored in a manner to prevent any obstruction to a UAV suspension system from transferring a container 100 into or out of the storage station 800, and an extended position in which the extendable arm 858 is positioned to align the load-bearing element 830 for engagement with a capture system of a container 100 that is positioned on the elevator platform 820. The downwardly tapering funnel 814 also includes an actuating system that is operable for interacting with a capture system of a container 100 so as to selectively engage and disengage the container 100 to and from both a UAV suspension system and a funnel suspension system, both of which are operable for moving containers 100 into and out of holding spaces of GDDs 300. Further details as to storage stations 800 are provided in U.S. patent application Ser. No. 15/821,266, the entire content and disclosure of which is hereby incorporated by reference.

The storage station control system 850 includes a central control unit (CCU) 851 that is inclusive of a memory for storing software applications and operational data, as well as a processor for executing applications and accessing operational data stored at the memory. Stored software applications and operational data may be updated through one or more communications relays. The control system 850 further includes a UAV approach unit 852; a UAV positioning unit 854; a side door unit 856; an elevator platform guiding unit 858; a top hatch unit 860; an actuator unit 862; a capture unit 864; a load-bearing unit 866; a funnel positioning unit 868; a telescoping unit 870; a funnel suspension unit 872; a power unit 880; and a communications unit 890. The power unit 880 may further include a local power source 882; an external power source 884; and a power transfer unit 886. The communications unit 890 may further include a UAV relay 892; a station relay 894; and a server relay 896. Further details as to the storage station control system 850 are provided in U.S. patent application Ser. No. 15/821,266, the entire content and disclosure of which is hereby incorporated by reference.

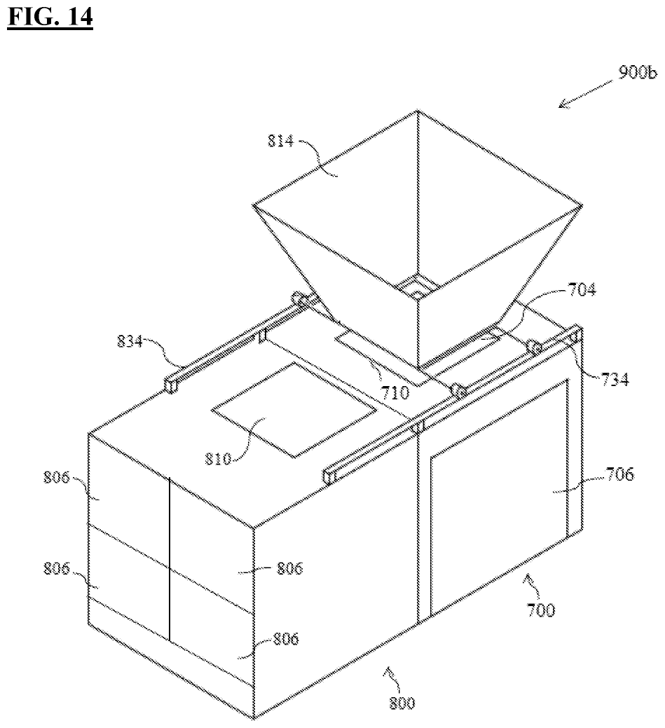

FIG. 14 show another example of a multi-unit service station 900b formed of multiple modular stations positioned side-by-side, including both a transfer station 700 and a storage station 800. Each modular station 700/800 may be constructed in similar fashion as though constructed as a singular station (e.g., a single transfer station 700, a single storage station 800), with the exception that the modular stations are aligned to cooperate with one another and share a funnel 814 that moves between the separate modular stations by travelling along tracks 734/834 that extend along the upper surfaces of each modular station in alignment with one another. Further details as to such multi-unit stations 900b are provided in U.S. patent application Ser. No. 15/821,266, the entire content and disclosure of which is hereby incorporated by reference.

One or more storage stations 800 may be deployed in the field as a component of a multi-unit station 900b together with one or more transfer stations 700, as illustrated in FIG. 14. Such a multi-unit service station 900b may be positioned at a location that serves as a common shipping hub for facilitating package transfers between separate service drones (e.g., GDD-UAV transfers; GDD-GDD transfers; and UAV-UAV transfers); and may also be positioned at a location that serves as a common shipping pick-up or drop-off location for facilitating container drop-offs and pick-ups by users.

When positioned at a common shipping hub, a multi-unit station 900b may avoid operational downtime of a drone that would otherwise result when a scheduled package exchange between two service drones 30 is delayed due to a late arrival of one drone. Specifically, if a package exchange is scheduled to occur between two drones and if the package drop-off drone arrives ahead of the package pick-up drone, the package drop-off drone may deliver the package-carrying container 100 to the multi-unit service station 900b for temporary storage in the storage station 800 until the package pick-up drone arrives to receive the package-carrying container 100. For example, in a GDD to UAV package exchange, if the package-carrying GDD 300 arrives ahead of the UAV 500, the GDD 300 may enter the transfer station 700 and the package-carrying container 100 may be extracted from the GDD 300 and deposited in a storage compartment 824 of the storage station 800 (an inter-station storage transfer). Subsequently, when the UAV 500 tasked with receiving the package arrives, the package-carrying container 100 may be transferred to the UAV 500 directly from the storage station 800 (a UAV pick-up transfer). Similarly, in a UAV to GDD package exchange, if a package-carrying UAV 500 arrives ahead of the GDD 300, the UAV 500 may deposit the package-carrying container 100 directly into the storage station 800 for storing in a storage compartment 824 (a UAV drop-off transfer). Subsequently, when the GDD 300 tasked with receiving the package arrives, the GDD 300 will enter the transfer station 700, and the package-carrying container 100 will be extracted from the storage station 800 and transferred to the GDD 300 through the transfer station 700 (an inter-station transport transfer). Similar temporary storage processes may be performed in GDD to GDD transfers and UAV to UAV transfers. Further details as to processes performed with temporary storage of containers 100 in a storage station 800 are provided in U.S. patent application Ser. No. 15/821,266, the entire content and disclosure of which is hereby incorporated by reference.

When positioned at a common shipping pick-up or drop-off location, the multi-unit service station 900b may facilitate user interaction with the shipping system 1 by enabling a user to directly deposit and extract packages for shipping. For example, when seeking to deposit a package for shipping, a user may open a side door 806 of the storage station 800 and insert the package directly into a storage compartment 824. Insertion of a package may require extracting a specialized container 100 from the storage compartment 824, placing the package into the container 100, and placing the container 100 with the package therein back into the storage compartment 824. Sometime thereafter, a service drone 30 (GDD 300 or UAV 500) will arrive and the package-carrying container 100 will be extracted from the storage compartment 824 and transferred to the drone for transport. Similarly, when seeking to receive a package that has been previously transported to a multi-unit service station 900b as the destination location, a user may open a side door 806 of the storage station 800 and extract the package from a storage compartment 824 into which the package was previously deposited after delivery by a service drone 30. Extraction of the package may require withdrawing a specialized container 100 that is carrying the package from the storage compartment 824, removing the package from the container 100, and placing the emptied container 100 back into the storage compartment 824.

In some instances, a storage station 800 may be positioned at a location as an independent structure, on its own, without attachment to a further station in a multi-unit station 900b. An independent storage station 800 may be positioned at a location that serves as a common UAV-only shipping hub for facilitating package transfers between separate UAVs 500; and may also be positioned at a location that serves as a common shipping pick-up or drop-off location that is serviceable only by UAVs 500. For example, an independent storage station 800 may be positioned at a location that would not be desirable or otherwise efficient for interaction with GDDs 300 (e.g., a platform at sea, a desert location, a mountain top location, etc.).

When a delivery server 200 determines that a storage station 800 (singular or in a multi-unit station) will assist in fulfilling a shipping request, the delivery server 200 communicates with the storage station 800 to provide identifying information as to a specific service drone 30 that is assigned to drop-off a specific package-carrying container 100 at the storage station 800 and as to a specific service drone 30 that is assigned to pick-up the specific package-carrying container 100 at the storage station 800. The delivery server 200 also communicates identifying information as to the specific package-carrying container 100 that is to be exchanged between the two identified drones. The storage station 800 stores the identifying information received from the delivery server 200 in the memory of the CCU 851. Subsequently, when a service drone 30 approaches the storage station 800, the storage station exchanges communication signals with the drone to receive identity information as to the specific drone and cross-references that information with the information stored at the CCU 851 to confirm the identity of the drone and the specific container 100 that is to be exchanged with that drone, thereby ensuring proper exchange of correct containers 100 between corresponding service drones 30.

When a storage station 800 is provided as one station in a multi-unit service station 900b in connection with a transfer station 700, a single one of the stations in that multi-unit service station may take responsibility for communications with the delivery server 200 for receiving drone and container identifying information, and may also take responsibility for communications with drones for cross-referencing identifying information. In such examples, the storage station 700 and transfer station 800 may communicate with one another through respective communications units 790/890 in order to share the identifying information and to effect deposit and extraction of specific containers 100 to and from storage compartments 824 of the storage station 800, as needed for executing specific container exchange tasks.

In operation, a user will initiate a package shipment by inputting a shipping request through a user device 11a that is linked with a delivery server 200 through a network 10. When entering the shipping request, the user will be prompted to enter certain identifying information, including, though not limited to, an origin location and a destination location. Preferably, the shipping request will also include identifying information as to the recipient of the package, including information enabling the delivery server 200 to initiate communications with a recipient-user device 11b. The delivery server 200 will assign a delivery identification number to the shipping request, and transmit the same to the users through the user devices 11a and 11b.

The sending-user will subsequently introduce the package for shipment into the shipping system 1 in association with the delivery identification number so that the delivery server 200 may track the package. A package may be introduced into the shipping system 1 in a number of ways. In a first example, a GDD 300 may arrive at the origin location and the sending-user may manually place the package directly into the holding space 303 of the GDD. In a second example, a sending-user may insert the package into a storage compartment 824 in a storage station 800, and a delivery drone (GDD or UAV) may subsequently retrieve the package from the transfer station 800. A sending-user may be given an opportunity to select both the preferred package drop-off method as well as the preferred package pick-up method when entering the initial shipping request.

When a user selects to manually place a package into a GDD 300, the delivery server 200 will prompt the user for an origin location for package pick-up, which may be at any real world location within the service region 20 (e.g., a residential or business address, a sidewalk location at or between road intersections, or simply any physical location). When selecting a manual exchange location, the user may designate the location via any suitable method, though preferably via a user interface that enables simplified entry of latitudinal and longitudinal coordinates (e.g., a map interface enabling a “pin-drop” location selection). After the user enters an origin location, the delivery server 200 selects a service drone 30 to travel to the origin location to pick-up the package, and calculates an estimated arrival time for the drone to arrive at the origin location. The delivery server 200 communicates the arrival time of the service drone 30 to the user through the user device 11a, so that the user may meet the drone to insert the package. The delivery server 200 may continue monitoring the service drone 30 selected for executing package pick-up, and may communicate an updated arrival time to the user device 11a if needed. When the user meets with the service drone 30, such as a GDD 300, the user will manipulate the user interface 307 so as to open the top hatch 304 and access the holding space 303. Preferably, manipulation of the user interface 307 will include entry of the delivery identification number assigned to the specific package being entered into the shipping system 1. Alternatively, the user may use the user device 11a to confirm entry of the package into the shipping system with entry of information that identifies the specific shipping asset into which the package was inserted (e.g., an identification number for a service drone 30 and possibly a specific holding space of that drone). When inserting a package into a GDD 300, the user will remove a specialized container 100 from the holding space 303, will insert the package into the container 100, and will then place the package-carrying container 100 back in the holding space 303 and close the top hatch 304. Once the GDD 300 determines the package has been received in the holding space 303 and that the top hatch 304 has been closed, the GDD 300 will then depart the origin location to travel to a next location assigned by the delivery server 200, which may be either the destination location or a waypoint location for package transfer or power renewal.

When a user selects to place a package into a storage station 800 for automated pick-up by a service drone 30, the delivery server 200 will either select a storage station 800 near to an address specified by the user or will provide the user with a list of available storage stations 800 to choose from. Upon identifying a storage station 800 that will receive the package, the delivery server 200 records the location of that storage station 800 as the origin location for reception of the package. The user then travels to the designated storage station and manipulates a user interface on the station so as to open a side door 806 of the storage station and access a storage compartment 824. The user interface on the storage station 800 may take any of the same forms as that of the user interface 307 of the GDD 300. Preferably, manipulation of the user interface at the storage station 800 will include entry of the delivery identification number assigned to the specific package being entered into the shipping system 1. Alternatively, the user may use the user device 11a to confirm entry of the package into the shipping system with entry of information that identifies the specific shipping asset into which the package was inserted (e.g., an identification number for a service station 40 and a specific storage compartment within that service station). When inserting the package into a storage station 800, the user will remove a specialized container 100 from the storage compartment 824, will insert the package into the container 100, and will place the package-carrying container 100 back in the storage compartment 824 and then close the side door 806. The user may then depart. Subsequently, a delivery-type service drone 30 (e.g., a GDD 300 or UAV 500) assigned to receive the package will arrive at the storage station 800 and will communicate with the station to identify the specific package-carrying container 100 to be picked-up, and to effect a transfer of the package-carrying container 100 from the storage station 800 to the service drone 30.

In another alternative, when a user chooses an automated exchange for package pick-up, the user may simply visit any storage station 800 and insert the package for shipping together with entry of the assigned delivery identification number through a user interface or through the use device 11a. Upon entry of the delivery identification number, the storage station 800 will communicate with the delivery server 200 to confirm reception of the corresponding package, and the delivery server 200 may then update a previously generated shipping agenda with the location of the storage station 800 set as the origin location.

Following introduction of a package into the shipping system 1, the delivery server 200 will communicate with the sending-user device 11a to confirm reception of the package. If provided with sufficient recipient-user information during initiation of the shipping request, the delivery server 200 may also communicate with the recipient-user device 11b to report reception of the package, and to prompt the recipient-user to confirm or alter the reception method for removing the package from the shipping system 1. As with the sending-user, the recipient-user may likewise receive the package via manual removal from the holding space of a GDD 300, or via retrieval from a storage compartment 824 of a storage station 800 following automated delivery thereto by a service drone 30 (e.g., a GDD 300 or UAV 500). Package reception methods are performed similarly to package insertion methods, via manipulation of user interfaces and removal of the package from a specialized container 100 in either the holding space 303 of a GDD 300 or a storage compartment 824 of a storage station 800. Manipulation of a user interface will preferably include entry of the delivery identification number assigned to the specific package being removed from the shipping system 1. Alternatively, the user may use the user device 11b to confirm removal of the package from the shipping system with entry of information that identifies the specific shipping asset from which the package is being extract (e.g., an identification number for a service drone 30 and possibly a specific holding space of that drone; or an identification number for a service station 40 and a specific storage compartment within that service station).

When a user is initially entering a shipping request through a user device 11a, the delivery server 200 will perform a number of steps to confirm that the specific shipping request can be made through the shipping system 1, and may also at that time generate a shipping agenda for fulfilling the shipping request. The shipping system 1 may begin by matching the user-selected origin and destination locations to mapping data stored in the memory of the server CCU 251 to confirm that both are within the service region 20 of the shipping system 1, and that both are serviceable in the manner requested by the user. If the system confirms that both locations are in the service region 20, and are serviceable in the manner requested, the delivery server 200 proceeds to generate a shipping agenda that may include a number of discrete transport tasks. The delivery server 200 subsequently uses the shipping agenda during execution of the shipping request to assign individual transport tasks to select shipping assets (e.g., service drones 30 and service stations 40) for fulfillment of the shipping request.

When generating the shipping agenda, the delivery server 200 may make a number of determinations, including, though not limited to, whether the user has requested manual or automated package exchange at the origin and/or destination locations; whether the origin and destination locations necessitate a long distance or short distance transport of the package; whether there are any ground restrictions between the origin and destination locations; whether there is a terrain change between the origin and destination locations; and whether there are any air-zone restrictions at either the origin or destination locations.

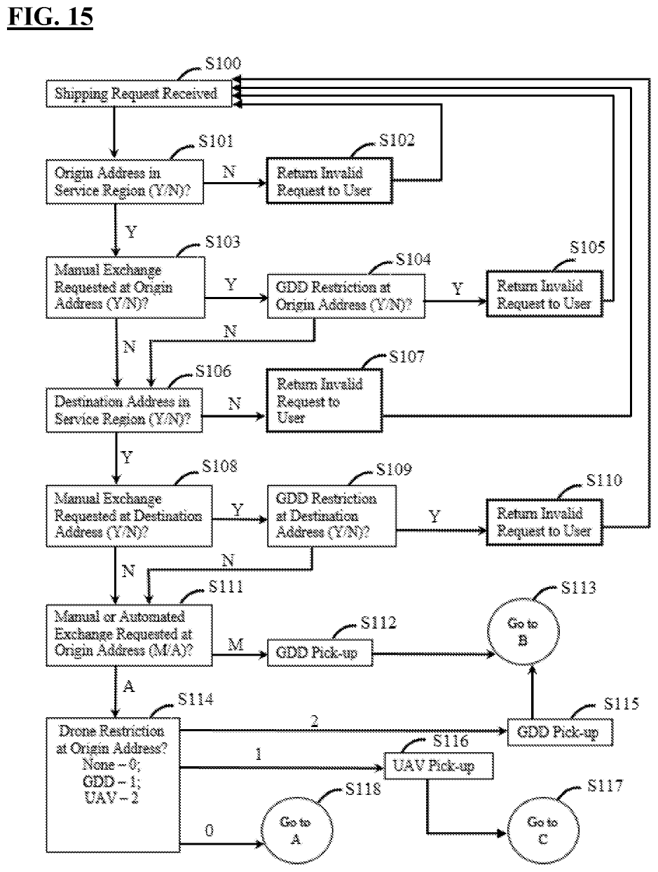

FIGS. 15-18 illustrate one example of the steps that may be taken by a delivery server 200 when generating a shipping agenda. Following reception of a shipping request in a step S100, the process will proceed to a step S101 in which the delivery server 200 determines whether the origin location selected by the user is within the service region 20. When an origin location is selected for a manual exchange at any real location in the world, the delivery server 200 will assess whether the coordinates of the selected location reside within the service region 20. On the other hand, when an origin location is selected for an automated exchange at service station 40, the delivery server 200 may simply assume that the selected location is within the service region 20. If the origin location is not in the service region, the process proceeds to a step S102 and the delivery server 200 sends a message to the user device 11a indicating that the selected origin location is invalid as not within a serviceable region of the shipping system 1 and prompts the user to enter an alternative origin location, and the process then returns to step S100 to await receipt of a renewed shipping request.

If the delivery server 200 confirms in step S101 that the origin location is properly within the service region 20, then the process proceeds to step S103 and the delivery server 200 determines whether the user has requested a manual exchange for package pick-up at the origin location. If the delivery server 200 determines that the user has requested a manual exchange for package pick-up at the origin location, then the delivery server 200 determines in a step S104 whether a GDD 300 may in fact travel to the selected origin location to effect a manual exchange. If the delivery server 200 determines that the origin location is not accessible by a GDD 300 (e.g., located at a mountaintop, a sea platform, etc.), then the delivery server 200 proceeds to a step S105 and sends a message to the user device 11a indicating that the request is invalid as a manual exchange cannot be performed at the selected origin location and prompts the user to either select an automated exchange for package pick-up or to designate an alternative origin location, and the process then returns to step S100 to await receipt of a renewed shipping request.

If the delivery server 200 determines either that a manual exchange is not requested at the origin location in step S103, or that a manual exchange is requested and can in fact be executed by a GDD 300 at the selected origin location in step S104, then the delivery server 200 proceeds to step S106 and determines whether the selected destination location is within the service region 20. If the destination location is not in the service region 20, then the process proceeds to a step S107 and the delivery server 200 sends a return message to the user device 11a indicating that the destination location is invalid as not being within a serviceable region of the shipping system 1, and prompts the user to enter an alternative destination location, and the process then returns to step S100 to await receipt of a renewed shipping request.

If the delivery server 200 confirms that the destination address is properly within the service region 20, then the process proceeds to step S108 in which the delivery server 200 determines whether the user has requested a manual exchange for package drop-off at the destination location. If the delivery server 200 determines that the user has requested a manual exchange for package drop-off at the destination location, then the delivery server 200 determines in a step S109 whether a GDD 300 may in fact travel to the selected destination location to effect a manual exchange. If it is determined that the destination location is not accessible by a GDD 300, then the delivery server 200 proceeds to a step S110 and sends a message to the user device 11a indicating that the request is invalid as a manual exchange cannot be performed at the selected destination location and prompts the user to either select an automated exchange for package drop-off or to designate an alternative destination location, and the process then returns to step S100 to await receipt of a renewed shipping request.

If the delivery server 200 determines either that a manual exchange is not requested at the destination location in step S108, or that a manual exchange is requested and can in fact be executed by a GDD 300 at the destination location in step S109, then the delivery server proceeds to step S111 in which it again determines whether the user has requested a manual or automated exchange at the origin location. If the user requested a manual pick-up at the origin location, then the delivery server 200 designates the package pick-up at the origin address as being executed by a GDD 300 in a step S112 and advances the process to a GDD pick-up routine in a step S113. Alternatively, if it is determined in step S111 that the user requested an automated pick-up at the origin location, then the delivery server 200 proceeds to step S114 to identify the selected service station 40 designated by the user for the automated exchange, and to assess if there are any drone access restrictions in place at the designated service station 40.

In step S114, if the delivery server 200 determines that the selected service station 40 has restricted access that preludes servicing by UAVs 500 (e.g., located in a restricted air-zone), then the delivery server 200 designates the package pick-up at the origin location as being executed by a GDD 300 in a step S115 and advances the process to the GDD pick-up routine in step S113. On the other hand, if the delivery server 200 determines that the designated service station 40 has restricted access that preludes servicing by GDDs 300, then the delivery server 200 designates the package pick-up at the origin location as being executed by a UAV 500 in a step S116, and advances the process to a UAV pick-up routine in a step S117. If the delivery server 200 determines there is not any restricted drone access conditions at the selected service station 40, then the delivery server advances the process to a step S118 for further processing.

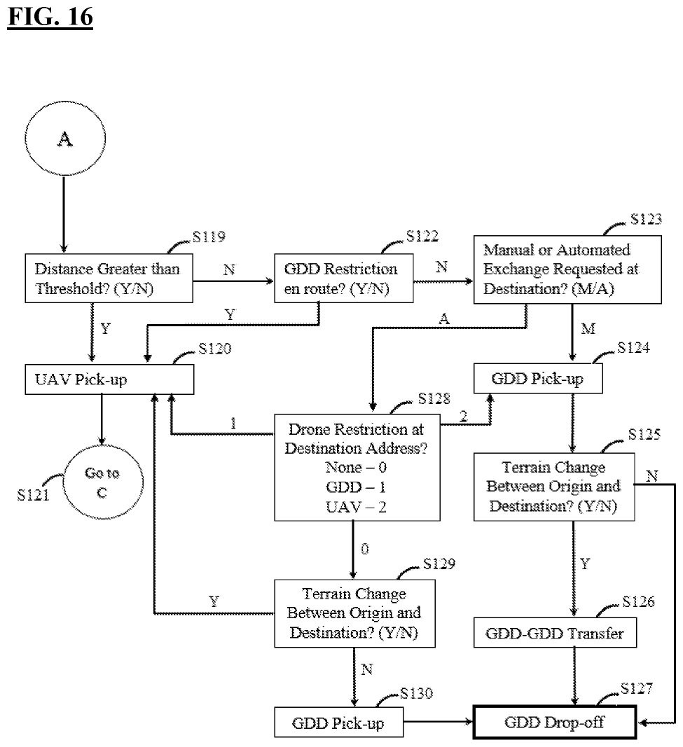

Moving from FIG. 15 to FIG. 16, as when the request is being further processed in accord with step S118 of FIG. 15, the delivery server 200 will make further determinations to assess a preferred delivery drone type for executing the initial package pick-up at the origin location. This further processing may begin, in a step S119, with the delivery server 200 determining the approximate distance between the selected origin and destination locations, and then determining whether that approximated distance is less than or greater than a predetermined distance threshold. The distance threshold will be a distance value that is set based on one or more variables that are informative as to whether the initial package pick-up at the origin location can be efficiently executed by a GDD 300, or if it greater efficiency can be achieved by having a UAV 500 execute package pick-up.

The distance threshold may be a distance value that has been predetermined to correspond with the maximum distance a GDD 300 can travel on a single battery charge before requiring power renewal. In such an example, if the distance between the origin and destination locations exceeds the preset distance threshold, then the delivery server 200 will designate the initial package pick-up for execution by a UAV 500 on the basis that execution of the pick-up by a GDD 300 would require a greater number of shipping assets (e.g., a GDD 300 and a GCD 400) and/or would result in a prolong transport time (e.g., due to requiring a GCD-GDD power renewal routine). In another example, the distance threshold may be a distance value that has been predetermined to correspond with an efficiency standard, such as a maximum transit time based on the average travelling speed of a GDD 300. In such an example, if the distance between the origin and destination locations is such that the travelling time for a GDD 300 to execute the pick-up would exceed a maximum transit time that has been preset as an efficiency standard, then the delivery server 200 may designate the package pick-up for execution by a UAV 500 on the basis that a UAV 500 can traverse the distance in a shorter time period that more closely complies with the pre-set efficiency standard.

If in step S119 the delivery server 200 determines that the approximated distance between the origin and destination locations exceeds the predetermined distance threshold, then the delivery server 200 will designate the pick-up of the package at the origin location for execution by a UAV 500 in a step S120 and advances the process to a UAV pick-up routine in a step S121. On the other hand, if the delivery server 200 determines in step S119 that the approximated distance is at or below the predetermined distance threshold, then the delivery server 200 will advance the process to a step S122 and make a further determination as to whether there is any GDD travel restrictions that would preclude travel of a GDD 300 between the origin and destination locations (e.g., as when the origin and destination locations are separated by a body of water with no option for land travel).

If it is determined in step S122 that there is a GDD travel restriction, then the delivery server 200 designates the pick-up of the package at the origin address for execution by a UAV 500 in step S120, and advances the process to a UAV pick-up routine in step S121. If it is determined in step S122 that there is not any GDD travel restriction, then the delivery server 200 will proceed to step S123 and will determine if the user has requested a manual or automated exchange at the destination location.

If it is determined in step S123 that the user requested a manual exchange at the destination location, then the delivery server 200 designates the package pick-up for execution by a GDD 300 in a step S124, and proceeds to a step S125 to determine if there is a terrain change between the origin and destination locations. The delivery server 200 may determine that there is a terrain change present in situations when a the origin location is in a first region having a first terrain and the destination location is in a second region having a second terrain that differs from the first terrain in the first region. For example, if the origin location is in a city region having paved roads and the destination location is in a marsh region having wetlands areas, then there may be needed a road-wheel type GDD 300 adapted for travelling along paved roads to execute a first portion of the shipping route including package pick-up at the origin location and a flotation-device type GDD 300 adapted for travelling along wetlands areas to execute a second portion of the shipping route including package drop-off at the destination location. Other special terrains that may be encountered in different regions may include snow and/or sand terrains which may require continuous-tread type GDDs 300 (e.g., caterpillar tracks).

If in step S125 the delivery server 200 determines there is a terrain change between the origin and destination locations, then the delivery server 200 will proceed to step S126 and schedule a GDD-GDD transfer for exchanging the package between two GDDs 300 of different types. After scheduling a GDD-GDD transfer in step S126, the delivery server 200 then designates package drop-off at the destination location in a step S127 as being executed by the receiving GDD 300 in the GDD-GDD transfer. Alternatively, if in step S125 the delivery server 200 determines there is no terrain change between the origin and destination locations, the delivery server 200 may proceed directly to step S127 and designate package drop-off at the destination location in step S127 as being executed by the same GDD 300 that executes package pick-up at the origin location.

Returning to step S123, if the user requested an automated exchange at the destination location, then the delivery server 200 proceeds to a step S128 to assess if there are any drone access restrictions in place at the selected service station 40. If the delivery server 200 determines that the selected service station 40 has restricted access that preludes servicing by GDDs 300, then the delivery server 200 designates the initial package pick-up at the origin location as being executed by a UAV 500 in step S120 and advances the process to a UAV pick-up routine in step S121. On the other hand, if the delivery server 200 determines that the selected service station 40 has restricted access that preludes servicing by UAVs 500, then the delivery server 200 designates the initial package pick-up at the origin location as being executed by a GDD 300 in step S124, and then proceeds with the determinations in steps S125-S127 as discussed above.

If the delivery server 200 determines in step S128 that there is not any restricted drone access conditions at the selected service station 40, then the delivery server 200 advances to a step S129 to determine if there is a terrain change between the origin and destination locations. The determinations made in step S129 are the same as those made in step S125, as discussed above. In this instance, if the delivery server 200 determines there is a terrain change between the origin and destination locations, then the delivery server 200 will designate the initial package pick-up at the origin location for execution by a UAV 500 in step S120 and advance the process to the UAV pick-up routine in a step S121, on the basis that execution by a UAV 500 may be more efficient by foregoing need of a GDD-GDD transfer. On the other hand, if the delivery server 200 determines in step S129 that there is not a terrain change between the origin and destination locations, then the delivery server 200 will designate a GDD 300 to execute initial package pick-up at the origin location in a step S130 and will then designate the same GDD 300 to execute final package drop-off at the destination location in step S127.

Moving from FIG. 15 to FIG. 17, when the delivery server 200 designates initial package pick-up at the origin location for execution by a GDD 300, and initiates a GDD pick-up routine in step S113 of FIG. 15, the delivery server 200 will then make further determinations to assess what, if any, further transport tasks will be needed for fulfillment of the shipping request. For example, in a step S131 the delivery server 200 may determine the approximate distance between the origin and destination locations, and may then determine if that approximated distance is less than or greater than the predetermined distance threshold. This determination is made in the same or similar manner as that discussed in step S119.

If the delivery server 200 determines in step S131 that the approximated distance between the origin and destination locations exceeds the predetermined distance threshold, then the delivery server 200 will proceed to a step S132 in which it will schedule a GDD-UAV transfer for transferring the package picked-up by GDD 300 to a UAV 500 on the basis that a UAV 500 can traverse the longer distance in a more efficient manner than a GDD 300. The delivery server 200 will then advance the process to a UAV pick-up routine in a step S133. On the other hand, if in step S131 the delivery server 200 determines that the approximated distance is at or below the predetermined distance threshold, then the delivery server 200 will advance the process to a step S134 in which a determination will be made as to whether there is any GDD travel restrictions that would preclude travel of a GDD between the origin and destination locations.

If it is determined in step S134 that there is a GDD travel restriction, then the delivery server 200 will schedule a GDD-UAV transfer in step S132 and then proceed to the UAV pick-up routine in step S133. If it is determined in step S134 that there is not any GDD travel restriction, then the delivery server 200 will proceed to step S135 and will determine if the user has requested a manual or automated exchange at the destination location.

If it is determined in step S135 the user requested a manual exchange at the destination location, then the delivery server 200 will proceed to a step S136 to determine if there is a terrain change between the origin and destination locations. This determination as to terrain change is made in the same or similar manner as that discussed in step S125. If the delivery server 200 determines there is a terrain change between the origin and destination locations, then the delivery server 200 will proceed to step S137 and schedule a GDD-GDD transfer for transferring the package from a GDD 300 that picked-up the package to a second GDD adapted for terrain in the region of the destination location. After scheduling a GDD-GDD transfer in step S137, the delivery server 200 then designates the second GDD 300 to execute package drop-off at the destination location in a step S138. On the other hand, if in step S136 the delivery server 200 determines there is no terrain change between the origin and destination locations, the delivery server 200 may proceed directly to step S138 and designate the same GDD 300 that executes package pick-up at the origin location to also execute package drop-off at the destination location.

Looking back to step S135, if it is determined that the user requested an automated exchange at the destination location, then the delivery server 200 will proceed to a step S139 to assess if there are any drone access restrictions in place at the selected service station 40. If the delivery server 200 determines that the selected service station 40 has restricted access that preludes servicing by GDDs 300, then the delivery server 200 will proceed to a step S140 and schedule a GDD-UAV transfer, and the delivery server 200 will then advance to a step S141 in which it will designate the UAV 500 from the GDD-UAV transfer for executing final package drop-off at the destination location. On the other hand, if the delivery server 200 determines in step S139 that the designated service station 40 has restricted access that preludes servicing by UAVs 500, or that there is no drone access restriction, then the delivery server will proceed with the determinations in steps S136-S138 as discussed above.

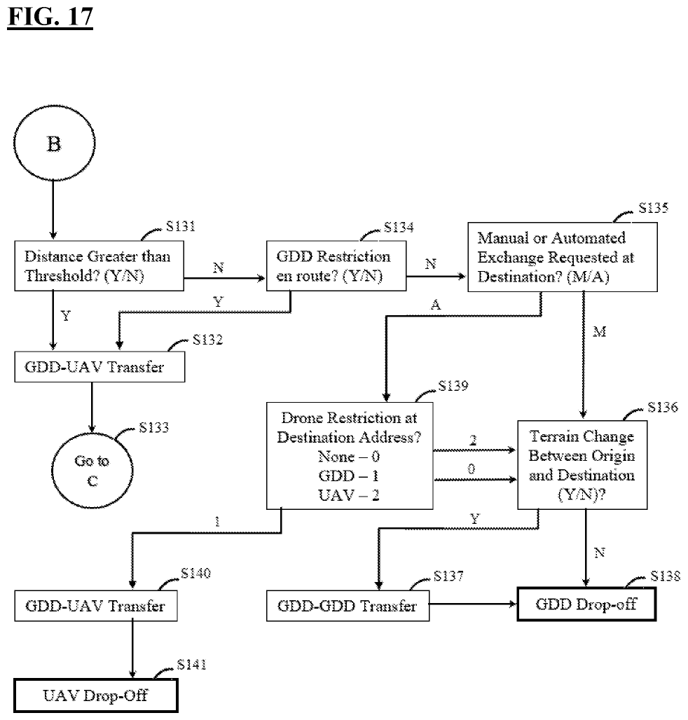

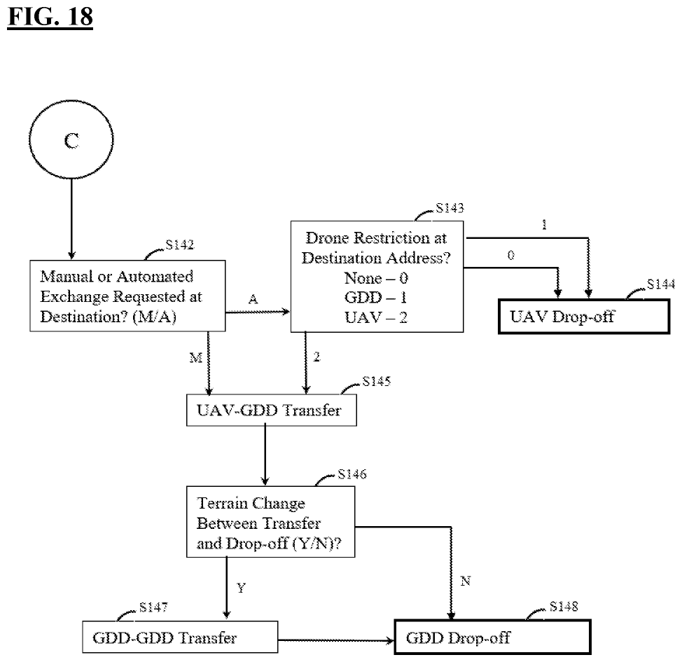

Moving to FIG. 18, as when proceeding to a UAV pick-up routine, either as a result of a UAV 500 being designated to execute package pick-up at the origin address in steps S116-S117 of FIG. 15 or steps S120-S121 of FIG. 16, or as a result of a UAV 500 being designated to execute a GDD-UAV transfer in steps S132-S133 of FIG. 17, the delivery server 200 will make further determinations to assess what, if any, further transport tasks will be needed for fulfillment of the shipping request.

In a step S142, the delivery server 200 will determine if the user has requested a manual or automated exchange at the destination location. If the user requested an automated exchange at the destination location, then the delivery server 200 proceeds to a step S143 to assess if there are any drone access restrictions in place at the designated service station 40. If the delivery server 200 determines that the designated service station 40 has restricted access that preludes servicing by GDDs 300, or that there is no drone access restriction, then the delivery server 200 proceeds to a step S144 in which it designates the UAV 500 that was designated to execute package pick-up (either at the origin location or in a package transfer) to also execute package drop-off at the destination location. On the other hand, if the delivery server 200 determines that the designated service station 40 has restricted access that preludes servicing by UAVs 500, then the delivery server 200 proceeds to a step S145 in which it schedules a UAV-GDD transfer for transferring the package in the UAV 500 to a GDD 300 for ground delivery to the destination location.

Following scheduling of a UAV-GDD transfer in step S145, the delivery server 200 then proceeds to a step S146 in which it determines if there is a terrain change between the selected service station 40 at which the package UAV-GDD transfer will occur and the destination location. This determination as to terrain change is made in the same or similar manner as that discussed in step S125. If the delivery server 200 determines there is a terrain change between the selected service station 40 and the destination location, then the delivery server 200 will proceed to step S147 and schedule a GDD-GDD transfer for transferring the package from the GDD 300 that receives the package at the UAV-GDD transfer to a second GDD 300 that is adapted for the terrain in the region of the destination location. Once the delivery server 200 has made arrangements for a GDD-GDD transfer in step S147, the delivery server 200 then designates the second GDD 300 that receives the package in the GDD-GDD transfer to execute final package drop-off at the destination location in a step S148. On the other hand, if in step S146 the delivery server 200 determines there is no terrain change between the service station 40 at which the UAV-GDD transfer is scheduled and the destination location, then the delivery server 200 may proceed directly to step S148 and designate the same GDD 300 that was designated for executing the package pick-up in the UAV-GDD transfer to also execute the final package drop-off at the destination location.

Looking back to step S142, if the user requested a manual exchange at the destination location, then the delivery server 200 proceeds to step S145 to schedule the UAV-GDD transfer, and then proceeds with the determinations in steps S146-S148 as discussed above.

Upon designating a service drone 30 for executing a final package drop-off at the destination location, in accord with the determinations illustrated in FIGS. 15-18, the delivery server 200 will have generated a shipping agenda for fulfillment of a shipping request.

In some instances, the shipping agenda may require only a single service drone 30 being tasked with travelling to the origin location to execute an initial package pick-up and then travelling to the destination location to execute a final package drop-off. A single-drone shipping agenda may be performed by a single GDD 300 or a single UAV 500.

In other instances, the shipping agenda may require two service drones 30 being tasked with executing two separate portions of a shipping request, with a first service drone 30 (a GDD 300 or UAV 500) being tasked with travelling to the origin location to execute an initial package pick-up and then travelling to a transfer site to meet with a second service drone 30 (GDD 300 or UAV 500) to perform a package transfer. The second service drone 30 is then tasked with travelling from the transfer site to the destination location and executing a final package drop-off. Such a shipping agenda may be performed, for example, in the sequence of GDD-GDD; GDD-UAV; UAV-UAV; UAV-GDD; or UAV-UAV.

In more complex shipping requests, the shipping agenda may require any number of service drones 30, with any number of package transfers between separate service drones 30, including, though not limited to shipping agendas following sequences such as GDD-UAV-GDD; GDD-UAV-GDD-GDD; UAV-GDD-GDD; GDD-UAV-UAV-GDD; GDD-UAV-UAV-GDD-GDD; and UAV-UAV-GDD-GDD. Individual package transfers between two service drones 30 may be executed through interactions with service stations 40—though may also be executed without the assistance of a service station 40, such as when executing a direct GDD-GDD transfer through the rear openings of the vehicle bodies.

When a shipping agenda requires a package transfer between a GDD 300 and a UAV 500, such will be executed by having the two drones meet at a service station 40 that is inclusive of a transfer station 700, either as a singular service station 30 or in a multi-unit station 900a/900b, and executing either a GDD-UAV transfer or a UAV-GDD transfer, such as those detailed in U.S. Pat. No. 9,975,651 and U.S. patent application Ser. No. 15/949,791, the entire content and disclosure both of which are hereby incorporated by reference.

When a shipping agenda requires a package transfer between a first UAV 500 and a second UAV 500, such will be executed by having the first package-carrying UAV 500 travel to a service station 40 that is inclusive of a storage station module 800, either as a singular service station 30 or in a multi-unit station 900b, and executing a UAV-to-storage transfer followed by the second UAV 500 travelling to the same service station 40 and executing a storage-to-UAV transfer such as those detailed in U.S. patent application Ser. No. 15/821,266, the entire content and disclosure of which is hereby incorporated by reference.

When a shipping agenda requires a package transfer between a first GDD 300 and a second GDD 300, such may be executed by having the first package-carrying GDD 300 travel to a multi-unit service station 900a/b that is inclusive of at least two service stations and a downward funnel 814 having a funnel suspension system for transferring containers 100 between separate GDDs 300—which may include temporary storage of the container 100 in a storage station 800, via a sequence of a GDD-to-storage transfer followed by a storage-to-GDD transfer, or which may instead be performed directly from GDD-to-GDD through two transfer stations 700.

GDD-GDD transfers may also be executed without the assistance of a service station 40 by executing a direct GDD-GDD transfer through the rear opens in the drone vehicle bodies that secures by rear hatches 305, as shown in FIGS. 3C-3D. For example, when the delivery server 200 determines that there is a terrain change in a delivery route between an origin location and a destination location, the delivery server 200 may schedule a GDD-GDD transfer for exchanging a package between a first package-carrying GDD 300 and a second package-receiving GDD 300′. The delivery server 200 may first attempt to identify a service station 40 that is located within a predefined distance of the delivery route for execution of a service station assisted GDD-GDD transfer. If the delivery server 200 is successful in identifying a service station 40 within the predefined distance, then the delivery server 200 will set the location of that service station 40 as a transfer site location for execution of the GDD-GDD transfer and will instruct the two GDD's 300 to travel to that transfer site and execute a service-station-assisted GDD-GDD transfer. However, if the delivery server 200 cannot identify a service station 40 within the predefined distance of the delivery route, then the delivery server 200 may instead identify a waypoint at a suitable location along the navigation route for execution of a GDD-GDD transfer, and will set that location as a transfer site and will then instruct the two GDD's 300 to travel to that transfer site and execute a direct GDD-GDD transfer.

Upon meeting at a waypoint-based transfer site (i.e., a non-service-station-assisted transfer site) under directions to execute a direct GDD-GDD transfer, two GDDs 300/300′ will communicate with one another through their respective communications units 390/390′ so as to coordinate positioning of the GDDs 300/300′ such that the rear ends 301b/301b′ abut one another, with the rear hatches 305/305′ facing one another. The GDDs 300/300′ may use the positioning sensors 320/320′ located at the rear ends 301b/301b′ of the vehicle bodies 301/301′, in connection with the positioning units 370/370′ of the respective drones to control fine movements for horizontally aligning the rear hatches 305/305′. The GDDs 300/300′ may alternatively use the environmental sensors in sensor arrays 306/306′ for controlling such fine movements and alignment.

In one example, when coordinating movements for executing a direct GDD-GDD transfer, a first GDD 300 will simply come to rest in a parked position at the transfer site, with the first GDD 300 taking any chosen orientation. The second GDD 300′ will then maneuver to position itself relative to the first GDD 300, with its rear end 301b′ facing generally opposite the rear end 301b of the first GDD 300. The second GDD 300′ will then move in reverse toward the first GDD 300 while the two GDD's monitor a relative positioning between the two vehicle bodies 301/301′ through their respective positioning sensors 320/320′ (or environmental sensors) and communicate with one another through their respective communications units 390/390′ such that the second GDD 300′ may make any necessary adjustments in its movement. The GDDs 300/300′ coordinate movement of the second GDD 300′ in this manner until the second GDD 300′ has moved to a position in which the rear ends 301b/301b′ of the two vehicle bodies 301/301′ abut one another.

Once the rear ends 301b/301b′ of the two GDDs 300/300′ are positioned to abut one another, the positioning sensors 320/320′ (or environmental sensors) on the rear ends 301b/301b′ of the GDDs 300/300′ will transmit signals to the respective GDD CCUs 351/351′ to indicate whether proper alignment has been achieved. The GDD CCUs 351/351′ may communicate their results with one another through the respective GDD communications units 390/390′. If it is determined that proper alignment has not been achieved, one of the two GDDs 300/300′ may move away from the other to reposition and re-maneuver to again attempt proper alignment of the rear ends 301b/301b′. Once it is confirmed that the two GDDs 300/300′ are positioned with their rear ends 301b/301b′ opposing one another, with the rear hatches 305/305′ properly aligned, the GDD CCUs 351/351′ each transmit a signal to the respective rear hatch units 360/360′ instructing opening of the corresponding rear hatches 305/305′. The GDD CCUs 351/351′ will confirm successful opening of the rear hatches 305/305′ with one another through the respective GDD communications units 390/390′.

The CCU 351 of the package-carrying GDD 300 will the transmit a signal to the corresponding conveyor unit 364 instructing a first conveyor motor to shift the conveyor belt 308 of that GDD 300 horizontally to protrude out through that GDD's rear opening and in through the rear opening in the package-receiving GDD 300′, such that the conveyor belt 308 of the package-carrying GDD 300 extends partially into the holding space 303′ of the package-receiving GDD 300′. The CCU 351 of the package-carrying GDD 300 will then transmit a further signal to the corresponding conveyor unit 364 instructing a second conveyor motor to initiate a running of the conveyor belt 308 in a direction to feed the package-carrying container 100 held thereon from the package-carrying GDD 300 to the package-receiving GDD 300′—optionally, the CCU 351′ of the package-receiving GDD 300′ will also transmit a signal to a corresponding conveyor unit 364′ instructing a conveyor motor to initiate a running of a conveyor belt 308′ in a direction to extract the package-carrying container 100 from the inserted conveyor belt 308 to facilitate transfer of the package-carrying container 100 from the first conveyor belt 308 to the second conveyor belt 308′.

Once the load unit 362 of the first GDD 300 (the package-carrying GDD) determines that the package-carrying container 100 has been removed fully from the conveyor belt 308 of the first GDD 300, the load unit 362 will transmit a signal to the CCU 351 of the first GDD 300 indicating the same, and that CCU 351 will then instruct the conveyor unit to 364 to cease running of the conveyor belt 308 and to retract the conveyor belt 308. Similarly, once the load unit 362′ of the second GDD 300′ (the package-receiving GDD) determines that the package-carrying container 100 has been received fully on the conveyor belt 308′ of the second GDD 300′, the load unit 362′ will transmit a signal to the CCU 351′ of the second GDD 300′ indicating the same, and that CCU 351′ will then instruct the conveyor unit to 364′ to cease running of the conveyor belt 308′. The two GDD CCUs 351/351′ will transmit further signals to the respective rear hatch units 360/360′ instructing closure of the corresponding rear hatches 305/305′, and the two GDDs 300/300′ will then depart the transfer site, with the second GDD 300′ traveling to the destination location (or the next transfer site) to drop-off (or transfer) the received package and the first GDD 300 either returning to a docking station 600 or travelling to execute a next assigned transport task.

A direct GDD-GDD transfer may normally be used for transferring package-carrying containers 100 between GDDs 300 when there is a terrain change requiring GDDs 300 of different types for execution of separate portions of a delivery route, and when there is not a conveniently located service station 40 for assisting with a package transfer. However, a direct GDD-GDD transfer may also be used when a package-carrying GDD 300 has suffered an operational failure such as a main power loss or a mechanical breakdown, such that a second GDD 300 may travel to and retrieve the package-carrying container 100 from the non-operational GDD 300, with the second GDD 300 then taking responsibility for the transport task that was previously assigned to the non-operational GDD 300.

It is noted that a direct GDD-GDD transfer may be performed through a hatch other than a rear hatch 305. For example, rather than rear hatches 305 at the rear ends 301b of the vehicle bodies 301, the GDDs 300 may be instead be constructed with side hatches at either side 301c and two GDDs 300 may coordinate to transfer containers 100 through such side hatches in substantially the same manner as would be done when transferring packages through the rear hatches 305 (e.g., via communication units 390/390′, positioning sensors 320/320′, positioning units 370/370′, sensor arrays 306/306′, and CCU's 351/351′). When constructed with a side hatch, a GDD 300 would also have a side hatch unit substantially identical to the rear hatch unit 360, though adapted for operation at a side surface 301c rather than the rear end 301b. GDDs 300 having a side hatch would also have a conveyor belt 308 and conveyor unit 364 that are operable for transferring containers 100 through the side passage, which may include the conveyor belt 308 in each GDD 300 being capable of horizontal movement for protruding out through the side passage of a first GDD 300 and in through the side passage of a second GDD 300′.

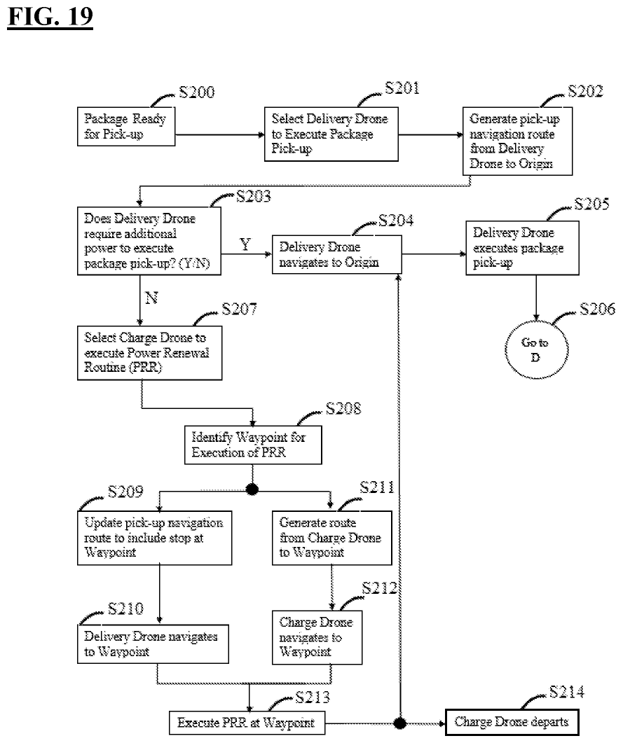

Once a shipping agenda is generated, the delivery server 200 may thereafter proceed to a package transport routine such as that shown in FIGS. 19-23. The package transport routine is inclusive, generally, of a package retrieval stage and a package delivery stage. Execution of a package transport routine generally includes steps for assigning individual shipping tasks to selected shipping assets (service drones 30 and service stations 40); generating navigation routes for retrieving and delivering packages; and executing service drone navigation and shipping asset interactions to fulfill shipping requests. Steps may also be performed, as needed, to update navigation routes for execution of one or more power renewal routines. Preferably, steps in the package transport routine are executed with reference to a previously generated shipping agenda that is specific to the particular package being transported in accord with a corresponding shipping request; with the shipping agenda being updated as needed based on changes that may occur during execution of the package transport routine, and fulfillment of the shipping request generally.

FIG. 19 illustrates one example of a package retrieval routine through which the delivery server 200 controls shipping assets to execute an initial package pick-up at an origin location. The origin location may be any location selected by a user for executing a manual package exchange with a delivery drone, or may be the location of a service station 40 into which the user will insert the package for a subsequent automated exchange with a delivery drone.

In a step S200, the delivery server 200 receives an indication that a package for a previously submitted shipping request is ready for pick-up. This indication may come either immediately upon a user's completion of entering a shipping request in which the user selects a manual exchange of the package at a selected origin location. Alternatively, the package-ready indication may come upon confirmation that the package has been inserted into a storage compartment 824 at a storage station 800, based on the user having selected an automated exchange and having subsequently accessed the storage compartment 824 with a corresponding entry of the delivery identification number either through a user interface or a user device 11a. Upon receiving an indication that the package is ready for pick-up, the delivery server 200 will refer to the previously generated shipping agenda, such as one generated in accord with the process set forth in FIGS. 15-18, to assess which shipping assets (e.g., service drones 30 and service stations 40) are needed for executing the shipping request.

In a step S201, the delivery server 200 references the shipping agenda to assess the type of delivery drone that is to be tasked with executing initial package pick-up at the origin location and then selects a corresponding delivery drone for travelling to the origin location to execute package pick-up, e.g., a GDD 300 or a UAV 500. Upon selecting a delivery drone, the delivery server 200 proceeds to step S202 and generates a navigation route from the current location of the selected delivery drone to the origin location. In a step S203, the delivery server 200 then communicates with the selected delivery drone to assess the current charge capacity of that drone's power unit and to determine if the current charge capacity is sufficient for the drone to travel to the origin location and execute package pick-up.

If the delivery server 200 determines in step S203 that the delivery drone has a sufficient charge capacity, then the process moves to step S204 and the delivery drone navigates to the origin location in accord with the navigation route generated by the server in step S202. Once arriving at the origin location, the delivery drone executes a package pick-up in a step S205, which may include either a manual exchange by a user interacting with the delivery drone or an automated exchange by the delivery drone interacting with a service station. Once the delivery drone is loaded with the package, the drone will communicate with the delivery server 200 to confirm retrieval of the package, and the delivery server 200 will proceed to a step S206 to initiate a package delivery routine.

Looking back to step S203, if the delivery server 200 determines that the delivery drone requires additional power to travel to the origin location and execute package pick-up, then the process moves to step S207 in which the delivery server 200 selects a nearby charge drone (e.g., a GCD 400) for meeting with the delivery drone to execute a power renewal routine. Once a charge drone is selected, the delivery server 200 determines the locations of the delivery drone and the charge drone and uses those locations, together with the origin location, in a step S208 to identify a preferred waypoint location at which the delivery and charge drones will meet to execute a power renewal routine.

Once a waypoint is identified in step S208, the delivery server 200 then executes two concurrent sequences—a first in steps S209-S210 and a second in steps S211-S212. In the first concurrent sequence, in step S209, the delivery server 200 updates the navigation route generated in step S202 to now include a stop at the waypoint identified in step S208, such that the new navigation route now presents a path from the current location of the delivery drone, to the waypoint, and then to the origin location. The delivery drone then executes the first portion of the updated navigation route in step S210 to travel to the waypoint. In the second concurrent sequence, in step S211, the delivery server 200 determines the current location of the selected charge drone and generates a navigation route from that location to the waypoint, and the charge drone then executes the navigation route to travel to the waypoint in step S212.

In a step S213, after both the delivery drone and the charge drone have arrived at the waypoint, the two drones cooperate with one another to execute a power renewal routine whereby the charge drone provides additional charge capacity to the power unit of the delivery drone through either a recharge routine in which electrical energy is transferred through mating power renewal interfaces (e.g., contact energy interfaces 387/487a; wireless energy interfaces 388/488) or through a replacement routine in which one or more power modules are exchanged between the drones (e.g., power modules 382 through corresponding module hatches 311/411).

Following execution of a power renewal routine in step S213, the delivery server 200 then executes two concurrent sequences—a first sequence in step S214 and a second sequence in steps S204-S206. In the first concurrent sequence, the delivery server 200 dismisses the charge drone, ending its involvement in the current shipping request. Dismissal of the charge drone may include an instruction that the drone travel to a service station to await a next task assignment, stay at the current position to await a next task assignment, or proceed to a next task assignment already assigned to that drone. In the second concurrent sequence, the delivery server 200 instructs the delivery drone to navigate to the origin location and execute package pick-up, and then initiates a package delivery routine, in the same manner as previously discussed relative to steps S204-S206.

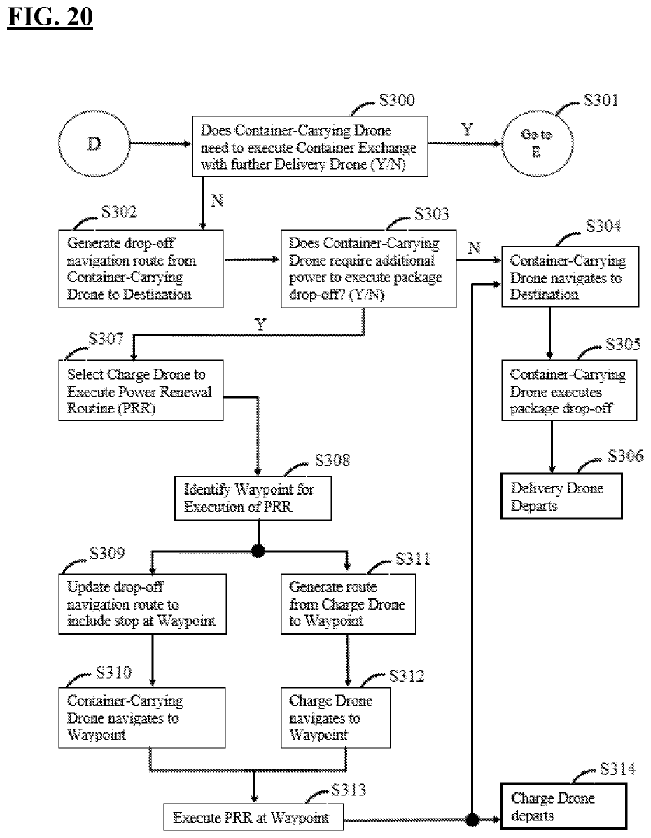

FIG. 20 illustrate one example of a package delivery routine through which the delivery server 200 controls shipping assets to execute a package drop-off at a destination location. The destination location may be any location selected by a user for executing a manual package exchange with a delivery drone, or may be the location of a service station from which a recipient user will retrieve the package following an automated exchange with a delivery drone.

When proceeding to a package delivery routine, the delivery server 200 will have already received confirmation from a delivery drone that it has taken possession of a package, such that the delivery drone is now a package-carrying drone. This confirmation of package retrieval will be associated with a delivery identification number, which will have previously been entered by the user when manually exchanging the package with the delivery drone or when inserting the package into a service station for an automated exchange with the delivery drone.

In a step S300, the delivery server 200 will use the delivery identification number to check the previously generated shipping agenda for the specific package to determine if the remainder of the shipping request is scheduled for completion by the current package-carrying drone, or if there is a need for the current package-carrying drone to execute a package transfer to pass the package-carrying container 100 to another delivery drone for execution of a next portion of the shipping request. For example, the delivery server 200 may determine that a package transfer is required when the current package-carrying drone is a GDD 300 and the shipping agenda indicates either that the shipping distance exceeds a predetermined threshold such that transport by a UAV 500 is deemed more efficient, or if the shipping agenda indicates that there is a terrain restriction that precludes ground delivery by a GDD 300. The delivery server may also determine that a package transfer is required when the current package-carrying drone is a UAV 500 and the shipping agenda indicates there is an air zone restriction at the destination location, such that ground delivery by a GDD 300 is required. The delivery server 200 may also determine that a package transfer is required when the current package-carrying drone is a GDD 300 of a first type, and the shipping agenda indicates there is a ground terrain change along the route that requires a GDD 300 of a second type.

If the delivery server 200 determines in step S300 that a package transfer is needed, then the process proceeds to a step S301 to initiate a package transfer routine. On the other hand, if the delivery server 200 determines in step S300 that a package transfer is not needed, then the process proceeds to a step S302 and the delivery server 200 generates a navigation route from the current location of the package-carrying drone to the destination location. In a step S303, the delivery server 200 then communicates with the package-carrying drone to assess the current charge capacity of that drone's power unit and to determine if the current charge capacity is sufficient for the drone to travel to the destination location and execute package drop-off.

If the delivery server 200 determines in step S303 that the package-carrying drone has a sufficient charge capacity, then the process moves to step S304 and the package-carrying drone navigates to the destination location in accord with the navigation route generated by the server in step S302. Once arriving at the destination location, the package-carrying drone executes package drop-off in a step S305, which may include either a manual exchange by a user interacting with the package-carrying drone or an automated exchange by the drone interacting with a service station.

Once the package is removed from the delivery drone, the drone will communicate with the delivery server 200 to confirm delivery of the package, and the delivery server will proceed to a step S306 in which the delivery drone is dismissed. Dismissal of the delivery drone may include an instruction that the drone travel to a service station to await a next task assignment, stay at the current position to await a next task assignment, or proceed to a next task assignment already assigned to that drone.

Looking back to step S303, if the delivery server 200 determines that the package-carrying drone requires additional power to execute package drop-off, then the process moves to step S307 in which the delivery server selects a nearby charge drone (e.g., a GCD) for meeting with the package-carrying drone to execute a power renewal routine. Once a charge drone is selected, the delivery server determines the locations of the package-carrying drone and the charge drone and uses those locations, together with the destination location, in a step S308 to identify a preferred waypoint location at which the package-carrying drone and charge drone will meet to execute a power renewal routine.

Once a waypoint is identified in step S308, the delivery server then executes two concurrent sequences—a first sequence in steps S309-S310 and a second sequence in steps S311-S312. In the first concurrent sequence, in step S309, the delivery server updates the navigation route generated in step S302 to now include a stop at the waypoint identified in step S308, such that the new navigation route now presents a path from the current location of the package-carrying drone, to the waypoint, and then to the destination location. The package-carrying drone then executes the first portion of the updated navigation route in step S310 to travel to the waypoint. In the second concurrent sequence, in step S311, the delivery server determines the current location of the selected charge drone and generates a navigation route from that location to the waypoint, and the charge drone then executes the navigation route to travel to the waypoint in step S312.

In a step S313, after both the package-carrying drone and the charge drone have arrived at the waypoint, the two drones cooperate with one another to execute a power renewal routine whereby the charge drone provides additional charge capacity to the power unit of the package-carrying drone through either a recharge routine in which electrical energy is transferred through mating power renewal interfaces (e.g., contact energy interfaces 387/487a; wireless energy interfaces 388/488) or through a replacement routine in which one or more power modules are exchanged between the drones (e.g., power modules 382 through corresponding module hatches 311/411).

Following execution of a power renewal routine in step S313, the delivery server 200 then executes two concurrent sequences—a first sequence in step S314 and a second sequence in steps S304-S306. In the first concurrent sequence, the delivery server 200 dismisses the charge drone, ending its involvement in the current shipping request. Dismissal of the charge drone may include an instruction that the drone travel to a service station to await a next task assignment, stay at the current position to await a next task assignment, or proceed to a next task assignment already assigned to that drone. In the second concurrent sequence, the delivery server 200 instructs the package-carrying drone to navigate to the destination location and execute package drop-off, and then dismisses the delivery drone, in the same manner as previously discussed relative to steps S304-S306.

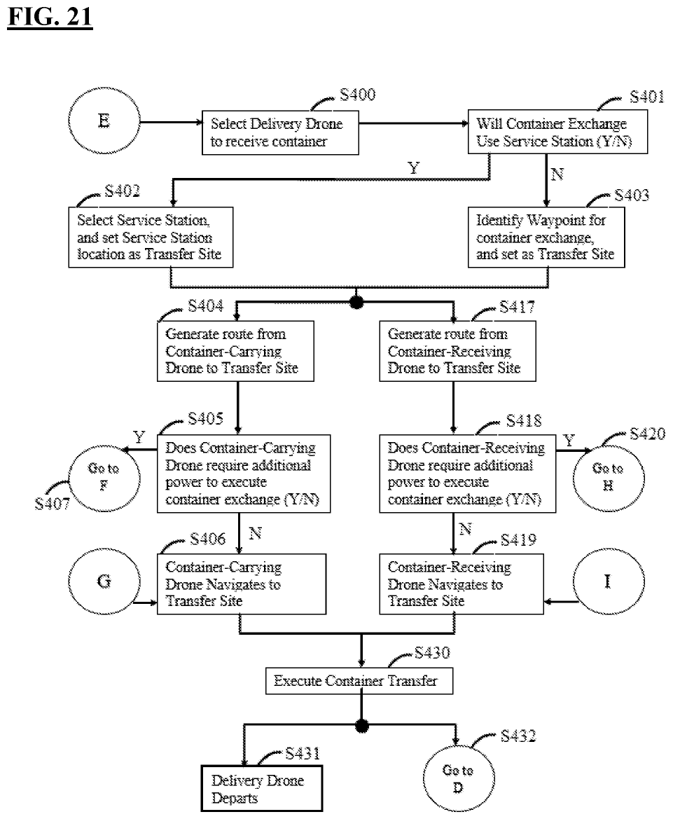

FIGS. 21-23 illustrate one example of a package transfer routine in which the delivery server 200 instructs shipping assets to execute a package exchange for transferring a package between a first package-carrying delivery drone and a second package-receiving delivery drone.

When initiating a package transfer routine, the delivery server 200 will have already received confirmation from a delivery drone that it has taken possession of a package, such that the delivery drone is now a package-carrying drone; and the delivery server will have already determined, such as in step S300, that the shipping agenda for the package being carried by the current package-carrying drone requires a package transfer so as to transfer the package from the current package-carrying delivery drone to a second package-receiving delivery drone.

In a step S400, having already determined that a package transfer is required, the delivery server 200 will select a second delivery drone that will serve as a package-receiving drone to meet with the current package-carrying drone for executing the package transfer. When selecting the package-receiving drone, the delivery server 200 will reference the shipping agenda corresponding to the package in question to determine the type of delivery drone that should be selected as the package-receiving drone for the specific package. For example, if the delivery server 200 determines that the current package-carrying drone is either a GDD 300 or a UAV 500 in a portion of the corresponding shipping agenda where there is indicated, respectively, a GDD-UAV or UAV-UAV transfer, then the delivery server 200 will select a UAV 500 as the package-receiving drone. On the other hand, if the delivery server 200 determines that the current package-carrying drone is either a GDD 300 or a UAV 500 in a portion of the corresponding shipping agenda where there is indicated, respectively, a GDD-GDD or UAV-GDD transfer, then the delivery server 200 will select a GDD 300 as the package-receiving drone.

Once the package-receiving drone has been selected in step S400, the process proceeds to step S401 in which the delivery server 200 determines if the package transfer will be executed through interaction with a service station. If the shipping agenda specifies that the package transfer is to be executed through interaction with a service station, then the process will proceed to step S402 in which the delivery server 200 will select a service station for use in executing the package transfer. When selecting a service station at step S402, the delivery server 200 will give preference to a service station that is determined to most promote an efficient delivery of the package. Most often, the delivery server 200 will determine that the most efficient service station to be one that is located closest in proximity to an otherwise direct delivery route between the current location of the package-carrying drone and the destination location of the package. In some instances, however, such as in GDD-UAV or UAV-GDD transfers, the delivery server 200 may determine that the greatest efficiency may be achieved by selecting a service station that is not the closest in proximity to an otherwise direct delivery route, but which is simply closest in proximity to the GDD 300. Specifically, the delivery server 200 may prioritize proximity to the GDD 300 over proximity to an otherwise direct delivery route if the delivery server 200 determines that the UAV 500 (in the GDD-UAV or UAV-GDD transfer) can execute package transport more efficiently, and if prioritizing proximity to the GDD 300 will permit the UAV 500 to execute a greater portion of the transport route. Upon selecting a service station, the delivery server 200 sets the location of that selected service station as a transfer site location.

If the delivery server 200 determines in step S401 that the shipping agenda specifies the package transfer to be executed without use of a service station, then the process will proceed to step S403 in which the delivery server 200 will determine the locations of the package-carrying drone and the package-receiving drone and uses those locations, together with the destination location, to identify a preferred waypoint location at which the package-carrying drone and package-receiving drone will meet to execute a package transfer. The waypoint location will then be set as a transfer site location.

Upon setting a transfer site location, in either step S402 or S403, the delivery server 200 then executes two concurrent sequences—a first sequence in steps S404-S406 (which may include steps S408-S416) and a second sequence in steps S417-S419 (which may include steps S421-S429).

In the first concurrent sequence, in step S404, the delivery server 200 generates a navigation route from the current location of the package-carrying drone to the transfer site, and in a step S405 the delivery server 200 then communicates with the package-carrying drone to assess the current charge capacity of that drone's power unit and to determine if the current charge capacity is sufficient for the drone to travel to the transfer site and execute a package transfer. If the delivery server 200 determines in step S405 that the package-carrying drone has a sufficient charge capacity, then the process moves to step S406 and the package-carrying drone navigates to the transfer site in accord with the navigation route generated in step S404.

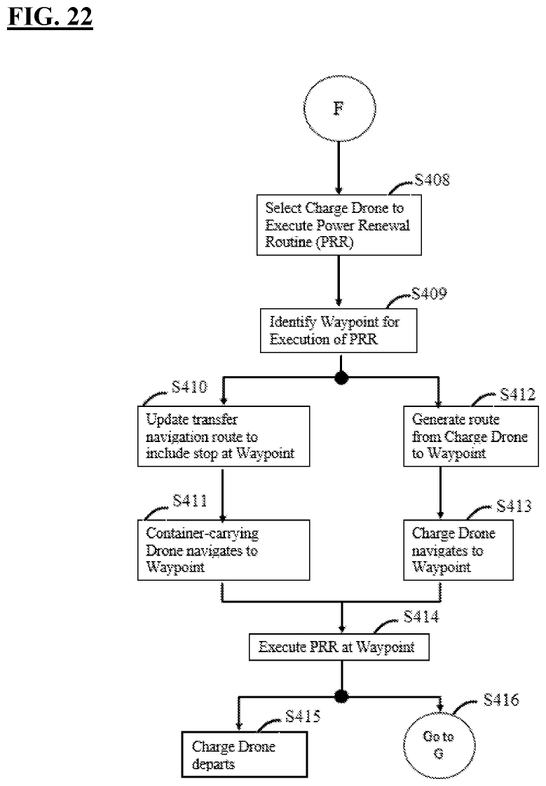

If the delivery server 200 determines in step S405 that the package-carrying drone does not have a sufficient charge capacity to travel to the transfer site and execute a package transfer, then the process moves to step S407 to initiate a power renewal routine. As shown in FIG. 22, a power renewal routine initiated through step S407 will include a step S408 in which a nearby charge drone (e.g., a GCD 400) is selected for meeting with the package-carrying drone to execute a power renewal routine. Once a charge drone is selected, the delivery server 200 determines the locations of the package-carrying drone and the charge drone and uses those locations, together with the transfer site location, in a step S409 to identify a preferred waypoint location at which the package-carrying drone and charge drone will meet to execute a power renewal routine.

Once a waypoint is identified in step S409, the delivery server 200 then executes two concurrent sequences—a first sequence in steps S410-S411 and a second sequence in steps S412-S413. In the first concurrent sequence, in step S410, the delivery server 200 updates the navigation route generated in step S404 to now include a stop at the waypoint identified in step S409, such that the new navigation route now presents a path from the current location of the package-carrying drone, to the waypoint, and then to the transfer site. The package-carrying drone then executes the first portion of the updated navigation route in step S411 to travel to the waypoint. In the second concurrent sequence, in step S412, the delivery server 200 determines the current location of the selected charge drone and generates a navigation route from that location to the waypoint, and the charge drone then executes the navigation route to travel to the waypoint in step S413.

In a step S414, after both the package-carrying drone and the charge drone have arrived at the waypoint, the two drones cooperate with one another to execute a power renewal routine whereby the charge drone provides additional charge capacity to the power unit of the package-carrying drone through either a recharge routine in which electrical energy is transferred through mating power renewal interfaces (e.g., contact energy interfaces 387/487a; wireless energy interfaces 388/488) or through a replacement routine in which one or more power modules are exchanged between the drones (e.g., power modules 382 through corresponding module hatches 311/411).

Following execution of a power renewal routine in step S414, the delivery server 200 then executes two concurrent sequences—a first sequence in step S415 and a second sequence in step S416. In the first concurrent sequence, in step S415, the delivery server 200 dismisses the charge drone, ending its involvement in the current shipping request. Dismissal of the charge drone may include an instruction that the drone travel to a service station to await a next task assignment, stay at the current position to await a next task assignment, or proceed to a next task assignment already assigned to that drone. In the second concurrent sequence, the process proceeds to step S416 and returns to the package transfer routine to execute step S406, with the package-carrying drone navigating to the transfer site for executing a package transfer.

Looking back to steps S402 and S403, in the second concurrent sequence following setting of a transfer site location in either such step, the delivery server 200 will proceed to a step S417 in which it will generate a navigation route from the current location of the package-receiving drone to the transfer site, and will then in a step S418 communicate with the package-receiving drone to assess the current charge capacity of that drone's power unit and to determine if the current charge capacity is sufficient for the drone to travel to the transfer site and execute package transfer. If the delivery server 200 determines in step S418 that the package-receiving drone has a sufficient charge capacity, then the process moves to step S419 and the package-receiving drone then navigates to the transfer site in accord with the navigation route generated by the server in step S417.

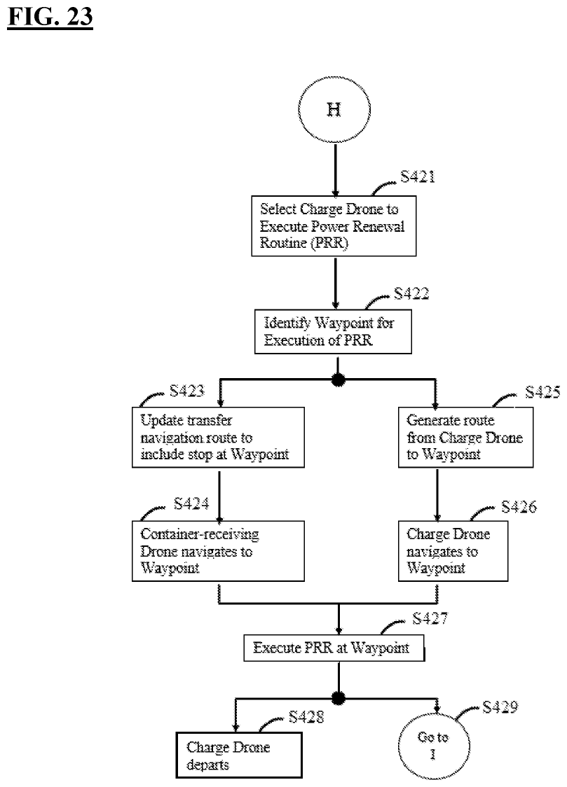

If the delivery server 200 determines in step S418 that the package-receiving drone does not have a sufficient charge capacity to travel to the transfer site and execute a package transfer, then the process moves to step S420 to initiate a power renewal routine. As shown in FIG. 23, a power renewal routine initiated through step S420 will include a step S421 in which a nearby charge drone (e.g., a GCD 400) is selected for meeting with the package-receiving drone to execute a power renewal routine. Once a charge drone is selected, the delivery server 200 determines the locations of the package-receiving drone and the charge drone and uses those locations, together with the transfer site location, in a step S422 to identify a preferred waypoint location at which the package-receiving drone and charge drone will meet to execute a power renewal routine.

Once a waypoint is identified in step S422, the delivery server 200 then executes two concurrent sequences—a first sequence in steps S423-S424 and a second sequence in steps S425-S426. In the first concurrent sequence, in step S423, the delivery server 200 updates the navigation route generated in step S417 to now include a stop at the waypoint identified in step S422, such that the new navigation route now presents a path from the current location of the package-receiving drone, to the waypoint, and then to the transfer site. The package-receiving drone then executes the first portion of the updated navigation route in step S424 to travel to the waypoint. In the second concurrent sequence, in step S425, the delivery server 200 determines the current location of the selected charge drone and generates a navigation route from that location to the waypoint, and the charge drone then executes the navigation route to travel to the waypoint in step S426.

In a step S427, after both the package-receiving drone and the charge drone have arrived at the waypoint, the two drones cooperate with one another to execute a power renewal routine whereby the charge drone provides additional charge capacity to the power unit of the package-receiving drone through either a recharge routine in which electrical energy is transferred through mating power renewal interfaces (e.g., contact energy interfaces 387/487a; wireless energy interfaces 388/488) or through a replacement routine in which one or more power modules are exchanged between the drones (e.g., power modules 382 through corresponding module hatches 311/411).

Following execution of a power renewal routine in step S427, the delivery server 200 then executes two concurrent sequences—a first sequence in step S428 and a second sequence in step S429. In the first concurrent sequence, in step S428, the delivery server 200 dismisses the charge drone, ending its involvement in the current shipping request. Dismissal of the charge drone may include an instruction that the drone travel to a service station to await a next task assignment, stay at the current position to await a next task assignment, or proceed to a next task assignment already assigned to that drone. In the second concurrent sequence, the process proceeds to step S429 and returns to the package transfer routine to execute step S419, with the package-receiving drone navigating to the transfer site for executing a package transfer.

In a step 430, after both the package-carrying drone and the package-receiving drone have arrived at the transfer site following execution of navigation steps S406 and S419, the two drones cooperate with one another to execute a package transfer from the first drone (the former package-carrying drone) to the second drone (the former package-receiving drone). This package transfer will be performed either through interaction with a service station, such as those interactions disclosed in U.S. Pat. No. 9,975,651 and U.S. patent application Ser. No. 15/949,791, or through direct interaction of the two delivery drones without an intermediate service station, such as that discussed relative to the GDD-GDD transfer in FIGS. 3C-3D. Once the package transfer is completed, the two delivery drones will communicate with the delivery server 200 to confirm successful package transfer, and the first drone (the former package-carrying drone) will be designated simply as a delivery drone and the second drone (the former package-receiving drone) will be designated as a package-carrying drone.

Following execution of a package transfer in step S430, the delivery server 200 then executes two concurrent sequences—a first sequence in step S431 and a second sequence in step S432. In the first concurrent sequence, in step S431, the delivery server 200 dismisses the delivery drone, ending its involvement in the current shipping request. Dismissal of the delivery drone may include an instruction that the drone travel to a service station to await a next task assignment, stay at the current position to await a next task assignment, or proceed to a next task assignment already assigned to that drone. In the second concurrent sequence, the process proceeds to step S432 and returns to the package delivery routine.

Upon returning to the package delivery routine through step S432, following execution of a package transfer, the delivery server 200 will again execute step S300 in which the server will use the delivery identification number to check the previously generated shipping agenda for the specific package to determine if the remainder of the shipping request is scheduled for completion by the current package-carrying drone, or if there is a need for the current package-carrying drone to execute a package transfer to pass the package-carrying container 100 to another delivery drone for execution of a next portion of the shipping request.

If the delivery server 200 determines in step S300 that a package transfer is not needed, then the process proceeds with steps S302-306 (which may include steps S307-S314) to complete delivery of the package to the destination location. On the other hand, if the delivery server 200 determines that the shipping agenda requires a further package transfer, then the process again proceeds to step S301 to initiate a further package transfer routine as shown in FIGS. 19-23. The package delivery routine may continue to cycle through any number of package transfer routines as specified in the shipping agenda, and returning to step S300 after each such transfer, until a determination is made in an occurrence of step S300 that no further package transfers are needed, after which the process will then proceeding with steps S302-306 (which may include steps S307-S314) to complete delivery of the package to the destination location.

FIG. 5C shows one example of a power renewal routine, executed as a recharge routine via mating contact energy interfaces. In the illustrated example, a delivery server 200 will have previously determined that a GDD 300 is in need of additional power for executing a transport task, or as a result of a power failure at the GDD 300. The delivery server 200 will have therefore instructed a GCD 400 to meet with the GDD 300 at a selected waypoint for execution of a power renewal routine. The waypoint may be any location along the navigation route of the GDD 300, or may be the current location of the GDD 300 if the GDD has such a low current power capacity that it cannot continue to travel.

Upon meeting at the designated waypoint under instructions to execute a power renewal routine, the GDD 300 and GCD 400 will communicate with one another through their respective communications units 390/490 so as to coordinate positioning of the two drones 300/400 such that the contact energy interface 487a of the GCD 400 is aligned generally with the contact energy interface 387 of the GDD 300. The drones 300/400 may use the positioning sensors 320/420 located on exterior surfaces of the vehicle bodies 301/401, in connection with the positioning units 370/470 of the respective drones to control fine movements for horizontally aligning the contact energy interfaces 387/487a. The drones 300/3400 may alternatively use the environmental sensors in sensor arrays 306/406 for controlling such fine movements and alignment.

In one example, when coordinating movements for aligning the power renewal units, a first drone (e.g., GDD 300) may simply come to rest in a parked position at the waypoint location, with the first drone taking any chosen orientation. The second drone (e.g., GCD 400) will then maneuver to position itself relative to the first drone, with its contact energy interface of that second drone facing generally opposite the contact energy interface of the first drone. The second drone will then either move closer to the first drone while the two drones monitor a relative positioning between the two vehicle bodies 301/404 through their respective positioning sensors 320/420 (or environmental sensors) and communicate with one another through their respective communications units 390/490 such that the second drone may make any necessary adjustments in its movements. The two drones 300/400 will coordinate movement of the second drone in this manner until the second drone has moved to a position in which the contact energy interfaces 387/487a are physically connected with one another. In the example shown in FIG. 5C, the drones need not move into full engagement with one another in order to connect the contact energy interfaces 387/487a. Instead, in the illustrated example, upon confirmation that the two drones are aligned, the CCU 451 of the GCD 400 may instruct the male contact energy interface 487a to extend from an internal housing of the vehicle body 401 to insert into the female contact energy interface 387 on the vehicle body 301 of the GDD 300.

Once the contact energy interfaces 387/487a are engaged, the respective drone CCUs 351/451 will instruct the power units 380/480 to execute an energy transfer by which energy from the GCD 400 (e.g., from a stored power module 382) is transferred through the contact energy interfaces 387/487a to the power module 382 of the GDD 300. This energy transfer may be performed with the two drones remaining in a parked position. Alternatively, once the contact energy interfaces 387/487a are engaged, the drones may begin travelling in synchronized movement, with the GDD 300 travelling along the navigation route for its assigned transport task and the GCD 400 executing movements synchronized to those of the GDD 300. In a yet further alternative, the two drones 300/400 may have engaged the contact energy interfaces 387/487a while the two drones were continuing to move, without having stopped in a parked position. This may be done by having the GDD 300 continue travelling along its navigation route and having the GCD 400 make an initial approach to the GDD 300 and then, when within a predetermined range, performing movements synchronized to the movements of the GDD 300 while approaching the GDD 300 and while relying on the foregoing interactions of the positioning sensors 320/420, communications units 390/490 and CCUs 351/451 to as to fully engage the contact energy interfaces 387/487a.

Once the GDD CCU 351 determines that the power module 382 of the GDD 300 has been adequately charged such that the GDD 300 may complete its assigned transport task (or once the power module 382 is fully charged), the CCU 351 will instruct the GDD communications unit 390 to send a signal to the GCD communications unit 490 indicating the same, and the GCD communications unit 490 will then relay a signal indicating the same to the GCD CCU 451. The CCUs 351/451 will then instruct disengagement of the contact energy interfaces 387/487a, after which the two drones will depart. Upon departing the GDD 300 continuing along its navigation route for execution of its assigned transport task. The GCD 400 will either travel to a service station 40 to await a further task, will remain at the then current position to receive a new task, or will travel to a newly assigned waypoint location to execute a newly assigned task.

A power renewal routine executed through the wireless energy interfaces 388/488 will be executed in much the same manner as that executed through the contact energy interfaces 387/487, with the exception that the two drones 300/400 need only position themselves adequately to generally align the wireless energy interfaces 388/488 without requiring an actual physical connection therebetween. Once the CCUs 351/451 of the two drones 300/400 determine that the drones are adequately positioned to align their wireless energy interfaces 388/488 (e.g., via positioning sensors 320/420, or sensor arrays 306/406), the CCUs 351/451 will instruct the drones to execute an energy transfer through the wireless energy interfaces 388/488. As with the contact energy interfaces 387/487, an energy transfer through the wireless energy interfaces 388/488 may be executed with the two drones stopped, or while the two drones continue to travel in synchronized movements.

As an alternative to executing a power renewal routine in the form of a recharge routine, a GCD 400 may instead meet with a GDD 300 to perform a power renewal routine in the form of a replacement routine in which the GCD 400 removes a depleted power module 382 from the GDD 300 and replaces it with a charged power module 382 that is stored in the GCD 400.

Upon meeting at a designated waypoint under directions to execute a power renewal routine, the GDD 300 and GCD 400 will communicate with one another through their respective communications units 390/490 so as to coordinate positioning of the two drones 300/400 such that a first module transfer interface on the GCD 400 (e.g., a transfer hatch 411 and optionally engagement mechanisms 412a and 412b) is aligned with a module transfer interface on the GDD 300 (e.g., a transfer hatch 311 and optionally engagement mechanisms 312a and 312b). The first module transfer interface on the GCD 400 will be one in which the module hatch 411 opens to an vacant module chamber 410.

The drones 300/400 may achieve positioning and alignment of the transfer modular interfaces in the same manner as done relative to the power renewal interfaces in the recharge routines. If the drones 300/400 include engagement mechanisms 312a/b and 412a/b, then following confirmation that the two drones are aligned, the CCUs 351/451 will instruct activation of the respective engagement mechanisms—for example, with an engagement arm in mechanism 412a of the GCD 400 being extended for insertion and locking within an engagement slot 312a of the GDD 300, and/or with an engagement arm in mechanism 312b of the GDD 300 being extended for insertion and locking within engagement slot 412b of the GCD 400.

Once the CCUs 351/451 determine that the two drones are adequately aligned, and optionally engaged via engagement mechanisms 312a/b and 412a/b, the CCUs 351/451 will instruct opening of the transfer hatches 311/411. If not previously done in response to a low energy status, the CCU 351 of the GDD 300 will at this time instruct that power responsibilities be temporarily shifted from the power module 382 to the power bank 384. The CCU 451 will then instruct the extension of a transfer arm from the module chamber 410, the gripping of an exposed surface of the depleted power module 382 by a manipulator of the transfer arm, and retraction of the transfer arm with the depleted power module 382 gripped thereby. With this sequence, a depleted power module 382 will be transferred from the module chamber 310 of the GDD 300 and into the vacant module chamber 410 of the GCD 400. The GDD 300 may continue to operate at this time by relying on a power supply from the power bank 384.

Following removal of the depleted power module 382, the two drones 300/400 will disengage the engagement mechanisms 312a/b and 412a/b (if provided) and will re-position so as to align a second module transfer interface on the GCD 400 (e.g., a transfer hatch 411 and optionally engagement mechanisms 412a and 412b) with the now vacant module transfer interface on the GDD 300 (e.g., a transfer hatch 311 and optionally engagement mechanisms 312a and 312b). The second module transfer interface on the GCD 400 will be one in which a module hatch 411 opens to an module chamber 410 that is storing a charged power module. The drones 300/400 will achieve re-positioning and alignment of the transfer modular interfaces in the same manner as done previously, which may again include the activation of respective engagement mechanisms 312a/b and 412a/b.

Once the CCUs 351/451 determine that the two drones are adequately aligned, and optionally engaged via engagement mechanisms 312a/b and 412a/b, the CCUs 351/451 will instruct opening of the transfer hatches 311/411. The CCU 451 will then instruct the extension of a transfer arm from the module chamber 410 with a charged power module 382 gripped by a manipulator of the transfer arm so as to insert the power module 382 into the vacant module chamber 310 of the GDD 300. Upon determining that the power module 382 has been properly inserted into the module chamber 310, the CCU 351 will instruct the GDD communications unit 390 to send a signal to the GCD communications unit 490 indicating the same, and the GCD communications unit 490 will then relay a signal indicating the same to the GCD CCU 451.

The CCU 451 will instruct the transfer arm manipulator to release the power module 382, and instruct the transfer arm to retract from the module chamber 310 and back into the now vacant module chamber 410, and the CCUs 351/451 will then instruct disengagement of the engagement mechanisms 312a/b and 412a/b (if provided). The CCU 351 will also instruct that power responsibilities be redirected to the power module 382 rather than the power bank 384. Preferably, so as to prepare for a future power module transfer, the CCU 351 may also at this time, or soon hereafter, instruct the full recharging of the power bank 384 either from the charged power module 382 or through a power renewal unit 486 (which may be done in further interaction with the present GCD 400, or via a renewable energy source through the passive energy interface 489). Once it is determined that the power renewal routine is completed, the two drones will depart.

In another example, both the GCD 400 and the GDD 300 may be provided with two module transfer interfaces, each having a module chamber 310/410, a module hatch 311/411 and engagement mechanisms 312a/312b and 412a/412b. In this example, both the GCD 400 and the GDD 300 would operate normally with one module chamber carrying a power module 382—e.g., as a power source in the GDD 300 and as a replacement module in a GCD 400—and with the other module chamber vacant. In this way, when executing a module transfer, the GCD 400 and GDD 300 may then effect a module exchange with a single engagement, without requiring repositioning. For example, once engaged, the GCD 400 would extract a depleted power module 382 from a first module chamber 310 of the GDD 300 and into the otherwise vacant module chamber 410 of the GCD 400—while at the same time inserting a charged power module 382 from the other module chamber 410 of the GCD 400 and into the otherwise vacant module chamber 310 of the GDD 300. Once this dual-exchange is completed, the GDD 300 would again have one module chamber 310 carrying a charged power module 382 and one vacant module chamber 310 ready for a subsequent module transfer—and the GCD 400 would have one module chamber 410 carrying a depleted power module 382 to be recharged and one vacant module chamber 410 ready for a subsequent module transfer.

As with power renewal routines executed as recharge routines, the power renewal routines executed as replacement routines may also be performed either with the two drones parked, or while the two drones remain travelling without having stopped.

Though the present invention is described with reference to particular embodiments, it will be understood to those skilled in the art that the foregoing disclosure addresses exemplary embodiments only; that the scope of the invention is not limited to the disclosed embodiments; and that the scope of the invention may encompass additional embodiments embracing various changes and modifications relative to the examples disclosed herein without departing from the scope of the invention as defined in the appended claims and equivalents thereto.

For example, though the foregoing discussion and drawings describe a GDD 300 as a service drone 30 that is provided with a vehicle body 301 having power renewal units 386 (e.g., a contact energy interface 387, a wireless energy interface 388, and/or a passive energy interface 389) and/or a power module transfer interface (e.g., a power module chamber 310, a module hatch 311 and engagement mechanisms 312a/b) it is understood that a UAV 500, as another service drone 30, may also be provided with a vehicle body have any one or all of the foregoing components. In examples where a UAV 500 has one or all of these power renewal units and/or power module transfer interface, the UAV 500 may take part in a power renewal routine with a GCD 400 by landing at a waypoint location such that the GCD 400 may interact with these units of UAV 500 in much the same way that the GCD 400 would otherwise interact with those same units on a GDD 300. Furthermore, whereas the GCD 400 is adapted for latching onto and travelling with a GDD 300 via mating engagement mechanisms 312a/b and 412a/b, the UAV 500 may likewise have the same engagement mechanisms for the GCD 400 to similarly latch onto the UAV 500, and the UAV 500 may then resume flight with the GCD 400 latched thereon.

In another example, through the foregoing discussion and drawings describe a GCD 400 as a charging drone that is provided with a vehicle body 401 having power renewal units 486 (e.g., a contact energy interface 487, a wireless energy interface 488, and/or a passive energy interface 489) and/or a power module transfer interface (e.g., a power module chamber 410, a module hatch 411, and engagement mechanisms 412a/b) it is understood that a UAV 500, as another service drone 30, may also be provided with a vehicle body have any one or all of the foregoing components. In examples where a UAV 500 has one or all of these power renewal units and/or power module transfer interface, the UAV 500 may operate as a charge drone for performing power renewal routines to transfer electrical energy to another service drone 30, including both GDDs 300 and a UAVs 500. Power renewal routines executed by an aerial charge drone may be performed either with the aerial charge drone landing at a waypoint location to interact with either a GDD 300 or another UAV 500, or by engaging another UAV 50 in midflight. Furthermore, with inclusion of engagement mechanisms such as those provided on the GCD 400 (e.g., engagement mechanisms 412a/b), the aerial charge drone may latch onto a GDD 300 that may resume ground travel, or a UAV 500 that may resume flight, such that the aerial charge drone may continue to execute a power renewal routine during travel of the delivery drone.

In some examples, the service stations 40 may also be constructed with a movement mechanism (e.g., a set of wheels) and propulsion unit that may enable autonomous driving of the service stations, such that a service station may periodically relocate between any number of positions as instructed for adapting to changing shipping demands. In this way, if demand in a certain area is high during certain times of the day, then a nearby service station that is not in use may relocate to the area of high demand to assist in the increased demand at that area.

In some examples, a drone communications unit may further include an external device relay that is adapted to exchange signals with devices external to the shipping system 1. For example, street lights, crossing signals, automated doors, elevators and lifts, and other vehicle and foot traffic indicators may be adapted to exchange signals on a predetermined channel or frequency dedicated to communicating with any service drone 30 that may be within a predetermined proximity of that external device, and the external device relay may be adapted to communicate on that same predetermined channel or frequency. Signals from external devices may be used to convey information including, but not limited to: safety for a ground-based service drone to traverse an intersection or cross-walk; timing for a ground-based service drone to enter through an opening in an automated door, elevator, or lift; similar safety and/or timing conditions for an aerial-based service drone to traverse a flight zone; and signals conveying the temporary blockade or closure of an otherwise available travel path (e.g., construction barricades along streets or sidewalks; newly constructed structures that extends into a previously available flightpath, etc.). It is to be further understood that all communications links discussed herein may be either direct, as shown in the drawings, or may include one or more intermediate communications devices or systems.

It is to be understood that the shipping assets here are scalable, and may be made to any suitable dimensions for accommodating the intended shipment needs. For example, delivery drones may be sized to provide transport of packages on an individual user basis, such that the drones may be dimensioned adequately to permit travel along footpaths (e.g., a drone measuring less than 3 feet by 3 feet adapted to travel along a sidewalk)—or the delivery drones may be sized to provide transport of packages on an wholesale or retail basis, such that the drones may be dimensioned adequately to permit travel along major traffic routes (e.g., a drone dimensioned comparably with a tractor trailer adapted to travel along a interstate highways). The charge drones will be sized as needed for conveying a power source commensurate with the delivery drones with which it is intended to interact, such that the charge drones may also be dimensioned to travel along either footpaths or major traffic routes. Delivery drones and containers transported thereby may take a number of various shapes and sizes, and service stations may be dimensioned as needed to accommodate such delivery drones, with any number of passages for the transfer of containers therethrough. Service stations may also be made without either front or back walls, so as to enable a drive-through type construction whereby a ground drone may traverse a service station from one side to another and receive a container while passing therethrough—which may enable construction of service stations in specialized traffic lanes along any major roadway, similar to low-speed lanes used for automated toll services.

Though the foregoing discussion addresses examples in which the shipping assets are used in the context of shipping services, it will be understood that this is but one non-limiting example of the invention and its use, and that the invention may be put to use for other purposes. For example, the inventive system may also be used to collect and relocate trash, including street sweeping services; may be used to refill other service machines such as autonomous dispensing machines (e.g., vending machines; automatic teller machines; etc.); and may be used for animal control in trapping and relocating wildlife.

It is also to be understood that the various sensors employed in the manner control system units and other components may take any form, as deemed appropriate for the give task—examples of which include, though are not limited to, sonar sensors, laser sensors, RFID sensors, touch sensors, pressure sensors, ultrasonic sensors, infrared sensors and weight sensors. Also, it is understood that all conveyor systems discussed herein, including those in the GDDs 300 (e.g., conveyor belt 308) and the storage stations 800 (e.g., conveyor belts 822), are not limited only to conveyor belts in the form of a continuously moving strip of material (i.e., a belt), but may include any suitable movement mechanism for transferring containers 100. For example, in each instance above where there is discussed a “conveyor belt”, there may instead be used an alternative conveyor systems of any suitable form, including through not limited to a modular conveyor system composed of several cellular modules that each comprise several omnidirectional wheels that are individually and selectively controlled by an electric motor, with the several cellular modules arranged and adapted for moving, positioning and re-orienting several objects simultaneously and independently on a platform. One example of such a modular conveyor system is the celluveyor system, available from Celluveyor, c/o BIBA—Bremer Institut für Produktion and Logistik GmbH, Hochschulring 20, 28359 Bremen, Germany.

It will be further understood that the shipping assets according to the present invention may include one or more safety systems, including caution lights or other signaling systems that activate when two or more shipping assets are interacting with one another for alerting bystanders, as well as one or more cameras or other monitoring systems for observing and/or recording operation of the shipping assets, and one or more shut-down systems for terminating operations of the shipping assets if there is detected a failure or emergency during operation thereof.

While the disclosed methods may be performed by executing all of the disclosed steps in the precise order disclosed, without any intermediate steps therebetween, it is to be understood that the methods may also be performed with further steps interposed between the disclosed steps, with the disclosed steps performed in an order other than the exact order disclosed, with one or more disclosed steps performed simultaneously, and with one or more disclosed steps omitted.

To the extent necessary to understand or complete the disclosure of the present invention, all publications, patents, and patent applications mentioned herein are expressly incorporated by reference herein to the same extent as though each were individually so incorporated. No license, express or implied, is granted to any patent incorporated herein.

The present invention is not limited to the exemplary embodiments illustrated herein, but is instead characterized by the appended claims.

What is claimed is:

1. An autonomous shipping system for transporting packages, comprising
a delivery server adapted to communicate with a network for receiving a shipping request from a user device that is also communicable with the network, the delivery server being further adapted to communicate with service drones for executing transport tasks for fulfilling a received shipping request, wherein
the delivery server is adapted to receive shipping requests specifying an origin location for an initial package pick-up and a destination location for a final package drop-off, and is further adapted to generate a shipping agenda for retrieving a package from the origin location and transporting the retrieved package to the destination location, the shipping agenda including selection of at least one service drone and generation of a navigation route for the at least one service drone,
the delivery server is communicable with service drones in the form of delivery drones that are adapted to hold and transport packages, and the delivery server is adapted to communicate with delivery drones to assign transport tasks to individual delivery drones, an assigned transport tasks including at least one of: travelling to an origin location to retrieve a package; travelling over at least a portion of the distance between an origin location and a destination location for transporting a package therebetween, and travelling to a destination location to drop-off a package, and
the delivery server is adapted, when communicating with a delivery drone selected to execute an assigned transport task, to assess a current charge capacity of a power unit of the selected delivery drone to determine if the selected delivery drone requires additional power in order to execute the assigned transport task, and
if the delivery server determines that the delivery drone does not require additional power, the delivery server instructs the delivery drone to travel along a first navigation route from its current location to a task location for execution of the assigned transport task, and
if the delivery server determines that the delivery drone does require additional power, the delivery server instructs the delivery drone to travel along a second navigation route from its current location to a waypoint location at which the delivery drone will execute a power renewal routine to receive additional power, and to then travel to the task location for execution of the assigned transport task.

2. The autonomous shipping system according to claim 1, wherein
delivery server is communicable with delivery drones in the form of ground delivery drones and aerial delivery drones.

3. The autonomous shipping system according to claim 1, wherein
the delivery server is adapted, when instructing a delivery drone to travel to a task location, to provide an origin location for executing initial package pick-up as the task location; provide a destination location for executing a final package drop-off as the task location; or provide a transfer site for executing a package transfer for exchanging a package with another delivery drone as the task location.

4. The autonomous shipping system according to claim 1, wherein
the delivery server is adapted to communicate with service stations in the form of docking stations, a docking station being adapted to execute a power renewal routine for providing additional power to a power unit of a delivery drone, and
the delivery server is adapted, when instructing a delivery drone to travel to a waypoint location to execute a power renewal routine, to provide the location of a docking station as the instructed waypoint location.

5. The autonomous shipping system according to claim 4, wherein
the autonomous shipping system further comprises a service drone in the form of a delivery drone and a service station in the form of a docking station,
the delivery drone comprises one or more power renewal units adapted for exchanging electrical energy in a power renewal routine, and the docking station comprises one or more power renewal units adapted for exchanging electrical energy in a power renewal routine, a power renewal unit of the docking station being adapted to mate with a power renewal unit of the delivery drone for executing a power renewal routine, and
mating power renewal units of the delivery drone and the docking station are chosen from at least one of: contact energy interfaces and wireless energy interfaces.

6. The autonomous shipping system according to claim 4, wherein
the autonomous shipping system further comprises a service drone in the form of a delivery drone and a service station in the form of a docking station,
a power unit of the delivery drone comprises a removable power module, and a vehicle body of the delivery drone comprises a module transfer interface through which a module chamber may be accessed for removing and inserting a power module, and
the docking station includes a module transfer interface adapted for accessing the module transfer interface of the delivery drone for removing a depleted power module from the module chamber and inserting a charged power module in the module chamber.

7. The autonomous shipping system according to claim 1, wherein
the delivery server is further adapted to communicate with service drones in the form of charge drones that are adapted to interact with delivery drones for executing power renewal routines for providing additional power to a power unit of a delivery drone, and
when instructing a delivery drone to travel to a waypoint location to execute a power renewal routine, the instructed waypoint location will be a location determined by the delivery server as a meeting location for the delivery drone and a charge drone.

8. The autonomous shipping system according to claim 7, wherein
the autonomous shipping system further comprises a service drone in the form of a delivery drone and a service drone in the form of a charge drone,
the delivery drone comprises one or more power renewal units adapted for exchanging electrical energy in a power renewal routine, and the charge drone comprises one or more power renewal units adapted for exchanging electrical energy in a power renewal routine, a power renewal unit of the charge drone being adapted to mate with a power renewal unit of the delivery drone for executing a power renewal routine, and
mating power renewal units of the delivery drone and the charge drone are chosen from at least one of: contact energy interfaces and wireless energy interfaces.

9. The autonomous shipping system according to claim 7, wherein
the autonomous shipping system further comprises a service drone in the form of a delivery drone and a service drone in the form of a charge drone,
a power unit of the delivery drone comprises a removable power module, and a vehicle body of the delivery drone comprises a module transfer interface through which a module chamber may be accessed for removing and inserting a power module, and
the charge drone includes a module transfer interface adapted for accessing the module transfer interface of the delivery drone for removing a depleted power module from the module chamber and inserting a charged power module in the module chamber.

10. The autonomous shipping system according to claim 7, wherein
the delivery server is further adapted, when instructing a delivery drone to travel to a waypoint location to execute a power renewal routine through an interaction with a charge drone, to also communicate with a selected charge drone to assign a transport task instructing the charge drone to travel to the waypoint location along a navigation route from the current location of the charge drone to the waypoint location.

11. The autonomous shipping system according to claim 7, wherein
delivery server is communicable with charge drones in the form of ground charge drones and aerial charge drones.

12. The autonomous shipping system according to claim 7, wherein
the autonomous shipping system further comprises a service drone in the form of a delivery drone and a service drone in the form of a charge drone,
when instructing the delivery drone to travel to a waypoint location to execute a power renewal routine in cooperation with a charge drone, upon meeting at the waypoint location, the delivery server instructs the delivery drone and the charge drone to execute a power renewal routine while the two service drones are aligned in parked positions.

13. The autonomous shipping system according to claim 7, wherein
the autonomous shipping system further comprises a service drone in the form of a delivery drone and a service drone in the form of a charge drone,
when instructing the delivery drone to travel to a waypoint location to execute a power renewal routine in cooperation with a charge drone, upon meeting at the waypoint location, the delivery server instructs the delivery drone and the charge drone to execute a power renewal routine while the two service drones are travelling along corresponding navigation routes.

14. The autonomous shipping system according to claim 13, wherein
when instructing the delivery drone and the charge drone to execute a power renewal routine while the two service drones are travelling along corresponding navigation routes, the delivery server instructs the two service drones to travel in synchronized movements.

15. The autonomous shipping system according to claim 13, wherein
when instructing the delivery drone and the charge drone to execute a power renewal routine while the two service drones are travelling along corresponding navigation routes, the delivery server instructs the two service drones to physically engage one another through mating engagement mechanisms on the vehicle bodies of the two service drones.

16. The autonomous shipping system according to claim 1, wherein
the delivery server determines if the selected delivery drone requires additional power in order to execute an assigned transport task by comparing the current charge capacity of the delivery drone to a calculated charge capacity for the assigned transport task, with the calculated charge capacity for the assigned transport task being based on a travel distance between the current location of the delivery drone and the task location and an estimated power-usage rate for the delivery drone to travel that distance.

17. The autonomous shipping system according to claim 1, further comprising:
a plurality of service drones, wherein the plurality of service drones comprises service drones in the form of delivery drones, and optionally service drones in the form of charge drones.

18. The autonomous shipping system according to claim 1, further comprising:
a plurality of service stations, wherein the plurality of service stations comprises service stations in the form of docking stations, optionally service stations in the form of transfer stations, and optionally service stations in the form of storage stations.

19. A method of transporting a package comprising:
transporting a package with a delivery drone that receives instructions from the autonomous shipping system according to claim 1.
